(19) United States
(12) Patent Application Publication
(10) Pub. No.: US 2017/0040653 A1
(43) Pub. Date: Feb. 9, 2017

(54) HEAT TRANSFER SYSTEM

(71) Applicant: Williams Grand Prix Engineering Limited, Oxford, Oxfordshire (GB)

(72) Inventors: Stephen Morris, Oxford, Oxfordshire (GB); Douglas Campbell, Oxford, Oxfordshire (GB)

(73) Assignee: Williams Gradn Prix Engineering Limited, Oxford, Oxfordshire (GB)

(21) Appl. No.: 15/303,680

(22) PCT Filed: Apr. 14, 2015
(86) PCT No.: PCT/GB2015/051127

§ 371 Date: Oct. 12, 2016

(30) Foreign Application Priority Data
Apr. 14, 2014 (GB) 1406692.2
Jan. 20, 2015 (GB) 1500945.9

(51) Int. Cl. H01M 10/6553; A62C 3/16; H01M 10/6557; H01M 10/6568; H01M 10/653; H01M 10/625

(52) U.S. Cl. CPC H01M 10/6553; H01M 10/653; H01M 10/625; H01M 10/6557; H01M 10/6568; A62C 3/16; H01M 2220/20

(57) ABSTRACT

A heat transfer system (100) for transferring heat from at least one electrical cell (124, 125, 126, 127). In particular, but not exclusively, the invention may be embodied as a heat transfer system (100) for transferring heat from at least one electrical cell (124, 125, 126, 127), the heat transfer system (100) comprising a generally planar and substantially flexible cooling bladder (107) comprising an internal fluid channel (117), wherein the bladder (107) is configured to be thermally coupled with an electrical connector (102), such as the terminal (128), of an electrical cell (124, 125, 126, 127) such that heat may be transferred from the electrical connector (102), or terminal (128), to said fluid channel (117).

The present invention relates to a heat transfer system for transferring heat from at least one electrical cell, a heat transfer system for cooling an electrical cell, a heat transfer system for cooling a plurality of electrical cells, a bladder for a heat transfer system and a fire suppressant system for an electrical cell. In particular, but not exclusively, the invention may be embodied in a cooling system for cooling the electrical cells of a battery pack and an automobile comprising such a cooling system.

The importance of keeping some of the electrical terminals of electrical cells in a battery pack electrically isolated is well known. The inadvertent electrical bridging of terminals can electrically short the battery and so may cause voltage output change and/or excessive heating in doing so. Therefore, there exists a higher risk of problems, such as fire, for electrical battery packs which do not adequately ensure that the electrical terminals of their electrical cells are sufficiently electrically insulated from each other.

In operation, electrical cells produce heat as a by-product of the chemical reactions occurring inside the electrical cells. Electrical cells operate most efficiently within a certain temperature range and so such heat may be beneficial in increasing the temperature of the cell to within the optimum temperature operating range of the cell, however, without a method of controlling the temperature of the cell, the temperature can quickly escalate to outside of the optimum temperature range, particularly under heavy load, and in certain circumstances, the temperature may even increase beyond a safe maximum temperature limit. When this happens, the electrical cells may catch fire. Therefore, in order to ensure the safe and optimum performance of an electrical cell it is desirable that a heat transfer means be provided to transfer heat at a desired rate away from an electrical cell or series of electrical cells.

One type of cooling that is known in the field of heat transfer is liquid cooling wherein a coolant is pumped through a fluid channel, such as a pipe, past a heat transfer surface of the item to be cooled. This type of heat transfer is particularly advantageous over other types such as natural convection because the rate of heat transfer can be precisely controlled by controlling the rate of fluid flow through the system.

A problem arises when using liquid cooling to cool the electrical terminals of an array of electrical cells as to how to ensure that there exists a good rate of heat transfer to the coolant from the electrical terminals while ensuring that the electrical cells do not short.

A known heat transfer system for an electrical cell, as described in U.S. Pat. No. 4,292,381, comprises an electrical cell having a positive and a negative terminal, the heat transfer system having internal blocks which are provided with ducts for receiving a cooling fluid and for removing excess heat from the battery. Such heat transfer systems have a large number of pipes and so are complex. Additionally, the ducts are formed within the terminals of the cells themselves and a number of connectors need to be provided to fluidly connect the terminals to the pipes of the liquid cooling system. Therefore, heat transfer systems of this type require a large number of fluid connections and so it can be extremely time consuming to disconnect and reconnect all of the fluid pipes when the cells need to be replaced or when maintenance needs to be performed on them.

A further known heat transfer system for an electrical cell assembly, as described in DE 10 2010 050 993 A1, comprises a series of electrical cells comprising terminals which are electrically connected by electrical blocks, each block comprising an inner cooling duct. Tubular connecting members fluidly connect one electrical block to the next in the series of electrical cells, thereby fluidly connecting the electrical blocks in series. As a result of this arrangement, a large number of tubular connecting members, or pipes, are required, each having a fluid connection at either end. Therefore, heat transfer systems such as these also require a considerable amount of time to disassemble and reassemble them for maintenance of the entire heat transfer system itself or of only the electrical cells. The disassembly and reassembly operation also, for environmental reasons, requires that the system be bled so that the coolant is not exposed to the surrounding environment. This further increases the complexity and time required during routine maintenance. Furthermore, opening up the fluid channels in this way each time the unit is disassembled can result in contaminants entering the fluid system and causing damage to it. In addition to these problems with disassembly and reassembly, as the fluid within the system is exposed to terminals of different polarity, this type of heat transfer system may be susceptible to accelerated corrosion of the electrical blocks thereby resulting in the assembly needing to be monitored more closely and maintained more often. Furthermore, electrolysis may occur between the electrical blocks such that one acts as an anode with the other acting as a cathode and, as can be appreciated, this can further accelerate the degradation of the electrical blocks and may cause gaseous by-products to build up in the liquid cooling system thereby causing additional problems with proper fluid flow.

A still further known heat transfer system for an electrical cell assembly, as described in DE 10 2008 034 867 A1, comprises a stack of electrical cells supported by a support frame, with a cooling plate arranged above the electrical contacts of the cells but electrically isolated from the contacts by a separate sheet of thermally conductive material. Heat transfer systems such as these require a separate sheet of material to be provided to ensure that the cooling plate does not short the electrical contacts of the electrical cells. Furthermore, such systems are unable to provide equal thermal contact on each of the cell contacts, particularly as the dimensions of electrical cells, and particularly pouch type electrical cells, are known to varying significantly according to the temperature of the cell. The variation in cell dimensions also provides difficulties in accommodating for the thermal expansion of the cells, both in supporting the cells in a housing and also ensuring good thermal contact with whichever heat transfer system is used, if any.

The present invention aims to alleviate, at least to a certain extent, the problems and/or address at least to a certain extent the difficulties associated with the prior art.

According to a first aspect of the present invention, there is provided a heat transfer system for transferring heat from at least one electrical cell, the heat transfer system including an electrical system, the electrical system including at least one electrical cell and at least one electrical connector, each electrical connector being configured to be in electrical and thermal communication with any one of said at least one electrical cell, the heat transfer system comprising a heat transfer means including a heat exchanger including an internal fluid channel or chamber, wherein the heat exchanger is configured to be thermally coupled with at least one of said at least one electrical connectors such that heat may be transferred from the at least one electrical connector which with the heat exchanger is configured to be thermally coupled to said fluid channel, and wherein the heat exchanger is configured to deform for substantial conformation with at least one electrical connector with which the heat exchanger is configured to be thermally coupled.

Such an arrangement enables heat to be transferred from at least one electrical cell, through its electrical terminal or terminals while reducing the risk of shorting the terminals. Advantageously, this arrangement also enables a single heat transfer means, for example comprising a single bladder, to be used to extract heat from the terminals of a number of electrical cells, regardless and irrespective of their polarity, without needed to provide separate provisions or components for electrically isolating the electrical terminals in order to prevent them from shorting. Additionally, the substantially thermally conductive and substantially electrically insulating material acts to electrically insulate fluid within the fluid channel from the electrical connectors. Consequently, a wider range of fluids can be used because whether the fluid is electrically conductive or not is immaterial. Additionally, as the material is substantially electrically insulating, the order in which the fluid conduit member contacts electrical terminals is irrelevant in terms of electrically shorting the terminals and so the present invention provides greater design freedom in designing a heat transfer system for electrical cells. The substantially thermally conductive and substantially electrically insulating material contacts at least two of the at least two electrical connections and as such may contact 3, 4, 5, or more of the at least two electrical connections.

Optionally, the heat exchanger is configured to substantially deform when subject to internal or external pressure.

According to a second aspect of the present invention, there is provided a bladder or vessel or chamber for containing a fluid for a heat transfer system according to Claim 1 or 2 comprising an internal fluid channel or chamber, wherein the bladder is configured to deform for substantial conformation with an electrical connector. The bladder may be configured as the heat exchanger of the heat transfer system.

Optionally, the bladder comprises the internal fluid channel or chamber.

Optionally, the bladder is substantially flexible. The bladder is optionally more flexible than components, e.g. the electrical connectors, with which it is coupled. A flexible bladder may have one surface, for example an underside or lower surface, thereof which is configured to substantially deform upon contact and a substantially opposing surface, for example an upper surface thereof which is not configured to substantially deform and, as such, may be substantially rigid, stiff or non-flexible. Therefore, only one surface of the bladder may be substantially flexible. Similarly, the bladder may be substantially flexible over only a portion of one surface, for example the underside surface, or it may be substantially flexible over the entirety of any one surface or substantially all of the surfaces of the bladder. The bladder, being flexible, may be substantially pliable, deformable or conformable and it may be configured to be able to adapt its shape upon the application of pressure to the external surface of the bladder, for example through contact of the bladder with another component of the heat transfer system, for example an electrical connector or terminal, so as to substantially conform to the shape of the component or such that the component is substantially impressed onto or into the surface of the bladder. When the heat transfer system is assembled, the bladder is in contact, preferable direct contact, with one or more electrical terminals or connectors of the electrical cells or stack of electrical cells.

Optionally, the bladder comprises a substantially thermally conductive and substantially electrically insulating material, wherein the bladder is configured such that heat may be transferred from at least one of said at least two electrical connectors to said bladder through said substantially thermally conductive and substantially electrically insulating material.

Optionally, the bladder is configured such that heat may be substantially transferred from at least one of said at least two electrical connectors, through said substantially thermally conductive and substantially electrically insulating material, to fluid within said bladder. In this way, heat is transferred from the electrical cell or cells to the bladder so that it may be dissipated to fluid within an internal compartment, chamber, pocket or fluid channel. The bladder may also be referred to as a pouch.

Optionally, the substantially thermally conductive and substantially electrically insulating material directly contacts at least one of the at least two electrical connectors. Direct contact of the thermally conductive and substantially electrically insulating material with the electrical connectors ensures a good rate of heat transfer from the connectors, which are thermally coupled to the internal components of their respective electrical cell, to the thermally conductive and substantially electrically insulating material and thereby to the bladder. Where the bladder is configured to contain fluid, such an arrangement ensures that heat from the electrical cells may be absorbed by the thermally conductive and substantially electrically insulating material and conducted or otherwise transferred to the fluid within the bladder.

Optionally, the substantially thermally conductive and substantially electrically insulating material directly contacts every electrical connector. Direct contact with every electrical connector of the electrical system ensures that heat is dissipated from each cell and therefore assists in maintaining the optimum operating temperature of each cell or prevents it from reaching or exceeding a predetermined maximum temperature.

Optionally, the bladder is configured such that heat may be substantially transferred from at least two of said at least two electrical connector to said bladder through said substantially thermally conductive and substantially electrically insulating material and wherein the substantially electrically insulating material extends continuously between at least two of the at least two electrical connectors from which the bladder is configured to receive heat. For example, the bladder may be manufactured substantially entirely from such thermally conductive and substantially electrically insulating material and therefore substantially the entirety of its external surface may comprise such thermally conductive and substantially electrically insulating material.

Optionally, the bladder is expandable. An expandable bladder provides that the bladder may expand to provide improved contact with the electrical connectors, for example in accordance to the internal pressure of the bladder, for example the internal fluid pressure of fluid within the bladder.

Optionally, the bladder is configured to substantially inflate or bulge upon the internal pressurisation of said bladder. An inflatable bladder provides that the bladder may inflate of bulge such that it may provide improved contact with the electrical connectors, for example in accordance to the internal pressure of the bladder, for example the internal fluid pressure of fluid within the bladder. Inflation of the bladder may cause a deflated, limp bladder to transition between a substantially deflated, limp configuration to a firm or substantially rigid configuration, even though the internal volume of the bladder or fluid channel or chamber may remain substantially constant. It may also cause the material of the bladder to elastically and/or plastically deform, stretch or distend so as to increase the overall volume of the bladder or the internal channel or chamber. When the bladder is configured to inflate such that it is substantially stretched, distended or elastically deformed, the material of the bladder has significant mechanical strain. The bladder may therefore be said to also be distensible, deformable or conformable.

The bladder may be sandwiched or compressed between an upper plate or housing and the electrical connectors, thereby providing increased pressure on the electrical connectors and improving the thermal contact between the connectors and the bladder. The bladder may also deform, e.g. inflate, without elastic deformation and/or plastic deformation.

Optionally, the bladder is configured to substantially inflate or bulge upon the pressurisation of fluid within said bladder.

Optionally, the bladder is configured such that heat may be substantially transferred from at least one of said at least two electrical connectors, through said substantially thermally conductive and substantially electrically insulating material, to a surface of said fluid channel. In this way, heat may be transferred to fluid within the channel.

Optionally, the length of the internal fluid channel is greater than the length of the bladder. Such an arrangement provides for an efficient heat transfer means.

Optionally, the fluid channel is arranged to pass substantially circuitously within said bladder. Thus, the fluid channel may meander within the bladder such that the fluid flow path substantially meanders, snakes or deviates within the bladder.

Optionally, the path of the fluid channel within the bladder is substantially planar.

Optionally, the internal fluid channel comprises flow diverters configured to alter the direction of flow of fluid within the bladder. The flow diverters may define the internal channel and the route taken by fluid flowing within the bladder by diverting, or changing the direction of, the fluid flow within the channel.

Optionally, the flow diverters are arranged along substantially opposing sides of the bladder. Thus, the flow diverters may be arranged such that the fluid path of the internal fluid channel zig-zags, snakes or meanders, across the width of the bladder.

Optionally, the flow diverters on the same opposing side are spaced substantially equally apart from each other.

Optionally, the flow diverters on one side of the bladder are staggered with respect to those on the opposing side.

Optionally, wherein the flow diverters comprise a rib or partition extending from an internal wall of the fluid channel.

Optionally, the bladder comprises a fluid inlet and a fluid outlet, both of which are configured to be in fluid communication with said internal fluid channel. A fluid inlet and a fluid outlet enable fluid to be supplied to and extracted from the bladder.

Optionally, the bladder comprises a plurality of such internal fluid channels.

Optionally, at least two of the plurality of such internal fluid channels are fluidly separated. A plurality of fluidly separated channels enable the bladder to comprise fluidly-separate cross-flow or parallel flow fluid channels such that the bladder may be configured as a cross-flow or a parallel flow heat exchanger or heat exchanging means.

Optionally, the plurality of fluid channels is configured to share a common fluid inlet and a common fluid outlet. A common inlet and outlet minimises the number of fluid connections to the bladder and therefore assists in assembly and maintenance by reducing the complexity of the fluid connections to the plurality of fluid channels.

Optionally, the bladder is fluidly connected to a fluid circuit comprising a fluid pump configured to pump fluid through said bladder.

Optionally, the bladder is configured such that fluid within said bladder does not directly contact any of said at least two electrical connectors. The present invention provides that fluid does not have to directly contact the electrical connectors in order to extract heat from them while at the same time ensuring that the electrical connectors remain electrically isolated from each other.

Optionally, the substantially thermally conductive and substantially electrically insulating material comprises a polymer.

Optionally, said polymer comprises Nylon. The Nylon may be boron doped Nylon.

Optionally, said fluid comprises or is a fire suppressant or retardant. Thus, in the event of fire or as a consequence of some other cause of overheating, the bladder may be configured to release the fluid, for example onto the fire in order to reduce or limit further heating of the electrical system.

Optionally, the electrical connector or connectors comprise or comprises an electrical cell terminal. The electrical cell terminals are the electrical tabs of the electrical cells.

Optionally, said electrical system comprises a plurality of said electrical cells and wherein one electrical cell of said plurality of electrical cells comprises at least one of said at least two electrical connectors and at least another electrical cell of said plurality of electrical cells comprises at least another of said at least two electrical connectors, wherein the electrical system further comprises an electrically connecting means configured to electrically connect said at least one of said at least one of said at least two electrical connectors to at least one of said at least another of said at least two electrical connectors, thereby electrically connecting at least two of said plurality of said electrical cells.

Optionally, the plurality of said electrical cells is electrically connected in series, thereby forming a stack of electrical cells.

Optionally, said electrical system comprises a plurality of said electrical cells electrically connected in parallel.

Optionally, said electrical system comprises a plurality of said electrical cells electrically connected in series and a plurality of said electrical cells electrically connected in parallel.

Optionally, said electrical system comprises a plurality of said electrical cells electrically connected in series to form a stack, wherein a plurality said stacks are connected in parallel.

Optionally, said electrical system comprises a plurality of said electrical cells physically connected in series to form a stack.

Optionally, a plurality of said stacks are physically located substantially next to one another. The electrical cells may be arranged back-to-back in order to improve the compactness of the electrical assembly.

Optionally, the electrical connectors comprise a substantially planar surface and are aligned such that the substantially planar surfaces of the connectors are arranged generally co-planar with respect to each other. In this way, the electrical connectors may together make up a substantially common heat transfer surface from which the bladder may extract heat.

Optionally, the electrical connecting means comprise a substantially planar surface, wherein the electrical connecting means are aligned such that that the substantially planar surfaces of the electrically connecting means are arranged substantially co-planar with respect to each other. In this way, the electrical connecting means may together make up a substantially common heat transfer surface from which the bladder may extract heat. In one example, U-shaped connector brackets electrically connect the electrical connectors of the electrical cells and the U-shaped connectors are arranged such that the underside surface of the U-shape comprises the substantially planar surface of the electrically connecting means.

Optionally, the bladder is arranged substantially over the co-planar planar surfaces.

Optionally, the bladder is thermally coupled to the electrically connecting means.

Optionally, the bladder is configured to directly contact the electrically connecting means.

Optionally, the electrically connecting means comprises a substantially U-shaped bracket.

Optionally, the fluid channel is configured to pass sequentially over the electrical connectors in the order in which the electrical cells are electrically connected. Such an arrangement may provide the most efficient flow path or may reduce the overall flow path length where the fluid channel is configured to extract heat from a plurality of electrical cells.

According to a third aspect of the present invention, there is provided a heat transfer system for transferring heat from at least one electrical cell of a plurality of electrical cells, the heat transfer system comprising at least two electrical connections configured to be in thermal and electrical communication with at least two electrical cells, the heat transfer system further comprising an electrical connecting means configured to electrically connect at least two of said at least two electrical connections, the heat transfer system further comprising a heat transfer means comprising a fluid conduit member comprising a fluid channel, wherein said fluid conduit member comprises a substantially thermally conductive and substantially electrically insulating material configured to contact at least two of said at least two electrical connections, the fluid conduit member being configured such that heat may be substantially transferred from at least one of said at least two electrical connections, through said substantially thermally conductive and substantially electrically insulating material, to fluid within said fluid channel.

This arrangement, and, in particular, a fluid conduit member comprising a substantially thermally conductive and substantially electrically insulating material configured to contact at least two electrical connections, enables heat to be transferred from at least one electrical cell, through its terminal or terminals, while reducing the risk of shorting the terminals. Advantageously, this arrangement also enables a single fluid conduit member to be used to extract heat from the terminals of a number of electrical cells, regardless of their polarity, without there being the need for multiple fluid connections along the length of the fluid channel to prevent the terminals from shorting. Additionally, the substantially thermally conductive and substantially electrically insulating material acts to electrically insulate fluid within the fluid channel. Consequently, a wider range of fluids can be used because whether the fluid is electrically conductive or not is immaterial. Additionally, as the material is substantially electrically insulating, the order in which the fluid conduit member contacts electrical terminals is irrelevant in terms of electrically shorting the terminals and so the present invention provides greater design freedom in designing a heat transfer system for electrical cells. The substantially thermally conductive and substantially electrically insulating material contacts at least two of the at least two electrical connections and as such may contact 3, 4, 5, or more of the at least two electrical connections.

Optionally, at least one of said at least two electrical cells comprises two of said at least two electrical connections configured such that, in use, a voltage exists between said two of said at least two electrical connections. The present invention is advantageous when a potential difference, or voltage, exists between two terminals contacted by the substantially thermally conductive and substantially electrically insulating material of the fluid conduit member and this material prevents the path of the fluid conduit member from adversely affecting the performance of the electrical cell or a group of electrical cells and prevents electrical shorting of their terminals.

Optionally, each of said at least two electrical cells comprises two of said at least two electrical connections configured such that, in use, a voltage exists between said two of said at least two electrical connections. Examples where each electrical cell comprises two electrical connections, or terminals, enable the electrical cells to be electrically connected together, for example in series, such that the number of cells can be selected to provide a predetermined combined voltage, or in order to attain some other desired outcome, for example to increase battery life (the energy capacity of the battery).

Optionally, the electrical connecting means is configured to electrically connect a plurality of said at least two electrical cells in series to thereby form a stack of electrical cells. By electrically connecting a plurality of electrical cells in series, the number of electrical cells can be selected to provide a predetermined potential difference across the stack of electrical cells. In some applications, it may be advantageous for the fluid conduit member to follow the order of the electrical terminals such that it generally follows the electrical path. However, other configurations are envisaged.

Optionally, the electrical connecting means is configured to electrically connect a plurality of said stacks of electrical cells in parallel. Thus, groups of stacks of electrical cells may be electrically connected in parallel in order to increase the battery life (energy capacity) of the group of stacks of electrical cells while not substantially increasing the combined potential difference across all of the stacks. However, the stacks may be in series or a battery pack may have stacks in series which are in parallel with others.

Optionally, the electrical connecting means is configured to electrically connect a plurality of said at least two electrical cells in parallel. Electrical cells electrically connected in parallel provide for a longer battery life (energy capacity) without increasing the combined potential difference across the electrical cells.

Optionally, the electrical connecting means does not comprise said fluid channel. In this way, the heat transfer system may be electrically connected and disconnected, for example during assembly and disassembly, without breaking the fluid channel or exposing it to external conditions and risking it becoming contaminated. This also means that the fluid channel does not have to be bled during assembly or disassembly.

Optionally, the substantially thermally conductive and substantially electrically insulating material extends continuously between at least two of said at least two electrical connections that the material is configured to contact. The substantially thermally conductive and substantially electrically insulating material extending continuously in this way reduces the likelihood that the electrical terminals will contact an area of the fluid conduit member other than the area that comprises this material, both while the apparatus is in use and during assembly and disassembly. It also provides a patch of material such that electrical cells of different sizes may contact the fluid conduit member, thereby enabling a greater design freedom in cell selection.

Optionally, a wall of said fluid channel comprises said substantially thermally conductive and substantially electrically insulating material. Thus, fluid in said fluid channel may directly contact the substantially thermally conductive and substantially electrically insulating material, thereby providing for a simpler fluid conduit member and enabling a direct heat transfer path from the electrical terminals to the fluid inside the fluid conduit member.

Optionally, the substantially thermally conductive and substantially electrically insulating material comprises a polymer.

Optionally, said polymer is Nylon. The fluid conduit member may also optionally comprise Nylon with a boron filler.

Optionally, the fluid channel is fluidly connected to a fluid circuit comprising a fluid pump configured to pump fluid through said fluid circuit. A fluid circuit and fluid pump provides a fluid flow through the fluid circuit and thereby through the fluid channel and may increase the rate of heat transfer from the electrical terminals.

Optionally, the heat transfer system further comprises a plurality of such fluid conduit members each comprising a fluid channel fluidly connected to said fluid circuit and wherein said pump is configured to pump fluid through said fluid circuit and each of said fluid channels. A plurality of fluid conduit members fluidly connected to the same circuit provides a simple means of transferring heat from a plurality of electrical cells without a single fluid conduit member having to snake from one electrical cell to the next in a stack of electrical cells. This may have the effect of reducing the total length of pipe or material required as the total fluid conduit length may be substantially reduced.

Optionally, at least one fluid channel of said plurality of fluid channels is fluidly connected in parallel with at least another fluid channel of said plurality of fluid channels. Fluid channels, and thereby fluid conduit members, fluidly connected in parallel provide multiple flow paths which may contact different rows of electrical cells of a stack of electrical cells so that a single fluid conduit member may not have to snake from one electrical cell to the next in a stack of electrical cells. This may have the effect of reducing the total length of pipe or material required as the fluid conduit path may be substantially reduced.

Optionally, said fluid channels fluidly connected in parallel share a common fluid inlet and fluid outlet. The fluid channels, or fluid conduit members, connected in parallel sharing a common fluid inlet and a common fluid outlet provide for a simpler fluid network with only two fluid junctions, an inlet fluid junction and an outlet fluid junction, to fluidly connect the fluid channels of the fluid conduit members, and thereby the fluid conduit members themselves.

Optionally, the heat transfer system comprises a dielectric fluid within said fluid channel or channels.

Optionally, the heat transfer system comprises a non-dielectric fluid within said fluid channel or channels.

Optionally, the heat transfer system comprises fluid within said fluid channel or channels wherein said fluid comprises or is a fire suppressant or retardant. A fire suppressant or retardant provided in the fluid in the fluid channels provides a means of extinguishing or slowing the progress of fire in or around the electrical cells if the fluid conduit member fails due to, for example, excessive heat such as from a nearby fire or from overheating of the electrical cells.

Optionally, the fluid conduit member or members is or are configured such that fluid within the fluid channel of each fluid conduit member does not contact any of said electrical connections. A fluid conduit member configured in this way prevents fluid within the fluid channels from shorting the electrical terminals and from causing corrosion of the electrical connections. Furthermore, the fluid does not have to be electrically insulating and so this arrangement provides for a greater freedom of choice of fluid.

Optionally, the heat transfer means is configured such that, in use, the primary mechanism of heat transfer to said fluid within said fluid channel is thermal conduction from said at least two of said at least two electrical connections, through said substantially thermally conductive and substantially electrically insulating material to said fluid within said fluid channel. This is the intended heat transfer path of heat from the electrical terminals to the fluid and provides an efficient and direct means of transferring excess heat from the electrical terminals to fluid with the fluid channels.

In a fourth aspect of the present invention, there is provided an automobile comprising the heat transfer system of the first, second or third aspects of the present invention. Such an automobile may be, for example, a car, van, truck, lorry, or motorcycle.

In a fifth aspect of the present invention, there is provided a heat transfer system for cooling an electrical cell, the heat transfer system comprising an electrical system, the electrical system comprising at least one electrical cell and at least two electrical connections, each in electrical and thermal communication with any one of said at least one electrical cell, the heat transfer system comprising a heat transfer means comprising a continuous and unbroken fluid conduit member comprising a substantially thermally conductive and substantially electrically insulating material which passes, contacts and extends continuously and unbrokenly between at least two of said at least two electrical connections.

Optionally, said fluid conduit member comprises a fluid channel. A fluid conduit member comprising a fluid channel provides a direct fluid path through the fluid conduit member and so may provide more efficient or effective cooling.

Optionally, said heat transfer means is configured such that heat may be substantially transferred from at least two of said at least two electrical connections, through said substantially thermally conductive and substantially electrically insulating material, to fluid contained within said fluid conduit member. This heat transfer path provides an efficient means of transferring heat to fluid within the fluid conduit member while electrically insulating the fluid from the electrical connections.

Optionally, said electrical system comprises a plurality of said electrical cells electrically connected in series, thereby forming a stack of electrical cells. In this way, the voltage of an electrical stack may be selected by connecting the necessary number of electrical cells in series to attain a required potential difference across the stack of electrical cells.

Optionally, said electrical system comprises a plurality of said electrical cells electrically connected in parallel. Electrical cells electrically connected in parallel provide for a greater battery life (energy capacity) while substantially maintaining the potential difference across the electrical cells.

Optionally, one electrical cell of said plurality of electrical cells comprises at least one of said at least two electrical connections and at least another electrical cell of said plurality of electrical cells comprises at least another of said at least two electrical connections, wherein the electrical system further comprises an electrically connecting means configured to electrically connect said at least one of said at least one of said at least two electrical connections to at least one of said at least another of said at least two electrical connections, thereby electrically connecting at least two of said plurality of said electrical cells. This arrangement provides a convenient means of electrically connecting a plurality of electrical cells, each having an electrical terminal.

Optionally, said electrical system comprises a plurality of said electrical cells electrically connected in series and a plurality of said electrical cells electrically connected in parallel. In this way, any combination of electrical cells connected in series and in parallel is envisaged. For example, the electrical system may comprise a plurality of stacks electrically connected in series, wherein each stack comprises a plurality of electrical cells electrically connected in parallel.

Optionally, said electrical system comprises a plurality of said electrical cells electrically connected in series to form a stack, wherein a plurality said stacks are connected in parallel.

Optionally, said electrical system comprises a plurality of said electrical cells physically connected in series to form a stack, wherein a plurality said stacks are physically located substantially next to one another. Stacks of electrical cells physically connected together and wherein the stacks are physically located next to one another provide for a compact battery and thereby a compact electrical system.

Optionally, the fluid channel is fluidly connected to a fluid circuit comprising a fluid pump configured to pump fluid through said fluid circuit. A fluid circuit and fluid pump provides fluid flow through the fluid circuit and thereby through the fluid channel and may increase the rate of heat transfer from the electrical terminals.

Optionally, the heat transfer system further comprises a plurality of such heat transfer means each comprising a fluid conduit member, each fluid conduit member comprising a fluid channel fluidly connected to said fluid circuit and wherein said pump is configured to pump fluid through said fluid circuit. A plurality of fluid conduit members may be configured to provide alternative fluid paths or may enable shorter sections of fluid conduit members to be used to be connected to the electrical terminals. This may reduce the quantity of substantially thermally conductive and substantially electrically insulating material required and thereby the cost of such material.

Optionally, at least two of said plurality of fluid channels are fluidly connected in series. Fluid channels, and thereby fluid conduit members, fluidly connected in series enable short lengths of fluid conduit members in a longer fluid path to be swapped out and replaced or repaired if one become damaged without having to replace the entire length of fluid conduit member or pipe

Optionally, at least one fluid channel of said plurality of fluid channels is fluidly connected in parallel with at least another fluid channel of said plurality of fluid channels. Fluid channels, and thereby fluid conduit members, fluidly connected in parallel may provide for a shorter total fluid path length and may provide for increased heat transfer performance when compared to a single fluid channel or path receiving heat sequentially from a plurality of electrical terminals in turn wherein the fluid at the distal end of the fluid channel will be warmer, and therefore the rate of heat transfer will be reduced, than fluid at the proximate end.

Optionally, said fluid channels fluidly connected in parallel share at least one common fluid inlet and at least one fluid outlet. The fluid channels, or fluid conduit members, connected in parallel sharing a common fluid inlet and a common fluid outlet provides for a simpler fluid network with only two fluid junctions, an inlet fluid junction and an outlet fluid junction, to fluidly connect the fluid channels of the fluid conduit members, and thereby the fluid conduit members themselves.

Optionally, said fluid conduit member or members is or are configured such that fluid within said fluid conduit member does not contact any of said at least two electrical connections. A fluid conduit member configured in this way prevents fluid within the fluid channels from shorting the electrical terminals and from causing corrosion of the electrical connections. Further, the fluid does not have to be electrically isolating and so this arrangement provides for a greater freedom of choice of fluid.

Optionally, the substantially thermally conductive and substantially electrically insulating material comprises a polymer.

Optionally, said polymer is Nylon. The fluid conduit member may also optionally comprise Nylon with a boron filler.

Optionally, the heat transfer system further comprises fluid within said fluid conduit member, wherein said fluid comprises or is a fire suppressant or retardant.

In a sixth aspect of the present invention, there is provided an automobile comprising the heat transfer system of the fifth aspect of the present invention. Such an automobile may be, for example, a car, van, truck, lorry, or motorcycle.

According to a seventh aspect of the present invention, there is provided a heat transfer system for cooling a plurality of electrical cells, the heat transfer system comprising a plurality of electrical cells each having at least one electrical connection in electrical and thermal communication with its respective cell, the plurality of electrical cells being electrically connected to one another through each electrical cell's said at least one electrical connection, the heat transfer system further comprising a heat transfer means comprising a continuous and unbroken fluid conduit member comprising a fluid channel and comprising a substantially thermally conductive and substantially electrically insulating material contacting a plurality of said at least one electrical connections.

Optionally, said substantially thermally conductive and substantially electrically insulating material extends unbrokenly and continuously between said plurality of said at least one electrical connections. This arrangement provides a continuous and unbroken stretch or patch of substantially thermally conductive and substantially electrically insulating material extending unbrokenly and continuously along an exterior surface of the fluid conduit member to thereby provide electrical isolation between two electrical connections, or terminals, of the plurality of electrical cells.

Optionally, said substantially thermally conductive and substantially electrically insulating material passes at least one of said at least one electrical connections. A benefit of the thermally conductive and substantially electrically insulating material enables it to directly contact a number of electrical connections, or terminals, of the electrical cells without shorting them.

Optionally, a plurality of said plurality of electrical cells are electrically connected in series to thereby form a stack of electrical cells. In this way, the voltage of an electrical stack may be selected by connecting the necessary number of electrical cells in series to attain a required potential difference across the stack of electrical cells.

Optionally, a plurality of said plurality of electrical cells electrically connected in series are electrically connected in parallel. In this way, a plurality of electrical stacks each comprising a plurality of electrical cells connected in series may be electrically connected in parallel and which may increase the battery life (energy capacity) of the plurality electrical stacks without increasing the voltage across them.

Optionally, a plurality of said stacks of electrical cells are electrically connected in parallel.

Optionally, the heat transfer system may further comprise an electrically connecting means configured to electrically connect at least two electrical cells of said plurality of electrically connected electrical cells through each electrical cell's said at least one electrical connection. Such an electrically connecting means arrangement provides a convenient way of electrically connecting a plurality of electrical cells, each having an electrical terminal and provides an intermediate member between the electrical terminals of the electrically connected cells so that the electrical connecting means may act as a physical and electrical bridge between them. A separate electrically connecting means may also facilitate assembly and disassembly of stacks of electrical cells.

Optionally, the fluid channel is fluidly connected to a fluid circuit comprising a fluid pump means configured to pump fluid through said fluid circuit. A fluid circuit and fluid pump provides fluid flow through the fluid circuit and thereby through the fluid channel and may increase the rate of heat transfer from the electrical terminals.

Optionally, the heat transfer means may comprise a plurality of said continuous and unbroken fluid conduit members, the fluid channel of at least one of which is fluidly connected in parallel with at least another to said fluid circuit, wherein said fluid pump means is configured to pump fluid along at least both of said fluid channels. Fluid channels, and thereby fluid conduit members, fluidly connected in parallel may provide for a shorter total fluid path length and may provide for increased heat transfer performance when compared to a single fluid channel or path receiving heat sequentially from a plurality of electrical terminals in turn.

Optionally, the heat transfer means may comprise a heat exchanging means configured to dissipate heat from fluid within said fluid circuit. Such a heat exchanging means may comprise a heat exchanger or radiator and which may be fluidly connected to the fluid circuit.

Optionally, the substantially thermally conductive and substantially electrically insulating material comprises a polymer.

Optionally, said polymer is Nylon and may contain a boron filler.

Optionally, said fluid conduit member or members is or are configured such that fluid within said fluid conduit member does not contact any of said at least two electrical connections. A fluid conduit member configured in this way prevents fluid within the fluid channels from shorting the electrical terminals and from causing corrosion of the electrical connections. Further, the fluid does not have to be electrically isolating and so this arrangement provides for a greater freedom of choice of fluid.

Optionally, fluid within said fluid channel or channels comprises or is a fire suppressant or retardant.

According to a seventh aspect of the present invention, there is provided an automobile comprising the fire suppressant system of the sixth aspect.

According to a eighth aspect of the present invention, there is provided a fire suppressant system for an electrical cell comprising a heat transfer means comprising a fluid conduit member comprising a fluid channel, said fluid channel comprising a fluid containing a fire suppressant or retardant wherein said heat transfer means is configured to receive heat from at least one electrical cell and to release said fire suppressant or retardant substantially onto or around said at least one electrical cell.

Optionally, said heat transfer means is configured to release said fire suppressant or retardant when a predetermined temperature is reached. Advantageously, the heat transfer means may automatically release the fire suppressant or retardant, which may comprise fluid, as soon as the temperature of a component is exceeded in order to prevent the temperature from increasing further, for example, where the temperature increase is due to fire, by extinguishing the fire.

Optionally, the fluid conduit member is configured to burst or at least perforate and thereby release said fire suppressant or retardant fluid substantially onto or around said electrical cell when said predetermined temperature is reached. Advantageously, this provides an automatic means of releasing the fluid without the necessity of a control system or temperature sensor.

Optionally, said predetermined temperature is a temperature of the electrical cell. The temperature of the cell may be critical as it may be indicative of an imminent failure of the cell, such as by combustion.

Optionally, said predetermined temperature is a temperature of an electrical connection of at least one of said at least one electrical cell. The substantially thermally conductive and substantially electrically insulating material may contact one or more of the electrical terminals or connections of one or more electrical cells and so the fluid conduit member may burst or fail in some other way as a result of the temperature of the electrical connections exceeding some predetermined temperature.

Optionally, said predetermined temperature is a temperature of said heat transfer means.

Optionally, said predetermined temperature is a temperature of said fluid conduit member.

Optionally, said fluid conduit member is configured to release said fluid by mechanical failure of said fluid conduit member at said predetermined temperature.

Optionally, said predetermined temperature is a temperature of said fluid. A temperature sensor may be placed downstream of the fluid conduit member and may measure the temperature of the fluid with a fluid channel of the fluid conduit member.

Optionally, said fluid conduit member contacts at least one electrical contact of at least one of said at least one electrical cell.

Optionally, a substantially thermally conductive and substantially electrically insulating material of said fluid conduit member contacts said at least one electrical contact.

Optionally, said substantially thermally conductive and substantially electrically insulating material of said fluid conduit member contacts two of said at least one electrical contacts and extends unbrokenly and continuously between those electrical contacts which the substantially thermally conductive and substantially electrically insulating material contacts. This arrangement provides a continuous and unbroken stretch or patch of substantially thermally conductive and substantially electrically insulating material extending unbrokenly and continuously along an exterior surface of the fluid conduit member to thereby provide electrical isolation between electrical connections, or terminals, of electrical cells.

Optionally, the substantially thermally conductive and substantially electrically insulating material comprises a polymer.

Optionally, said polymer is Nylon and may contain a boron filler.

Optionally, said heat transfer means comprises a plurality of such fluid conduit members. A plurality of fluid conduit members may be configured to provide alternative fluid paths to enable the fire suppressant system to provide greater coverage of the electrical cells or may enable shorter sections of fluid conduit members to be used to be connected to the electrical terminals. This may reduce the quantity of substantially thermally conductive and substantially electrically insulating material required and thereby the cost of this material.

Optionally, one of said plurality of such fluid conduit members is fluidly connected to at least another of said plurality of such fluid conduit members.

Optionally, said fluidly connected fluid conduit members are fluidly connected in parallel.

Optionally, said fluidly connected fluid conduit members are fluidly connected to a fluid circuit.

Optionally, the fire suppressant system may comprise a fluid pump means configured to pump said fluid through said fluidly connected fluid conduit members. A fluid circuit and fluid pump provides fluid flow through the fluid circuit and thereby through the fluid channel and may increase the rate of heat transfer from the electrical terminals. Further, the pump means may provide sufficient fluid pressure for adequate distribution or dispersion of the fire suppressant or retardant fluid over the electrical cells and, where the fluid conduit member is configured to burst, may provide sufficient pressure to burst the walls of the fluid conduit member. The pump means may also continue to supply fire suppressant or retardant fluid after the initial release of fluid.

Optionally, the fire suppressant system further comprises said at least one electrical cell from which heat transfer means is configured to receive heat.

Optionally, the fire suppressant system further comprises a plurality of said at least one electrical cells wherein said plurality of said at least one electrical cells are electrically connected to one another.

According to a ninth aspect of the present invention, there is provided an automobile comprising the fire suppressant system of the eighth aspect.

The present invention may be carried out in various ways and a preferred embodiment of a heat transfer system in accordance with the invention will now be described by way of example with reference to the accompanying drawings, in which:

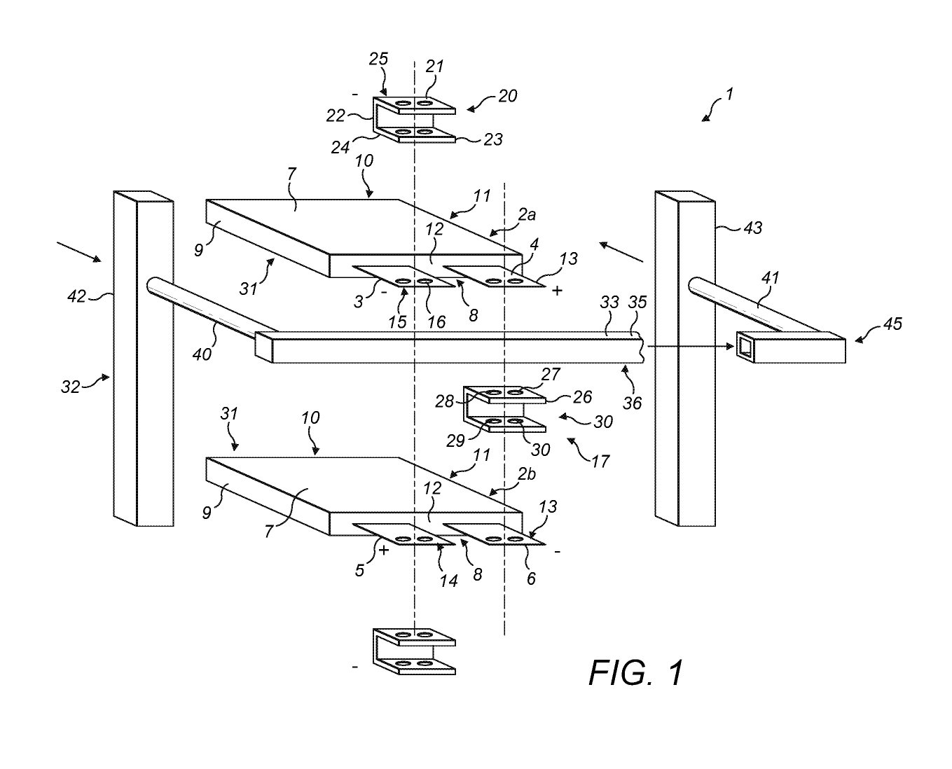

FIG. 1 is a schematic exploded view of parts of a preferred embodiment of a heat transfer system for transferring heat from electrical cells according to the present invention;

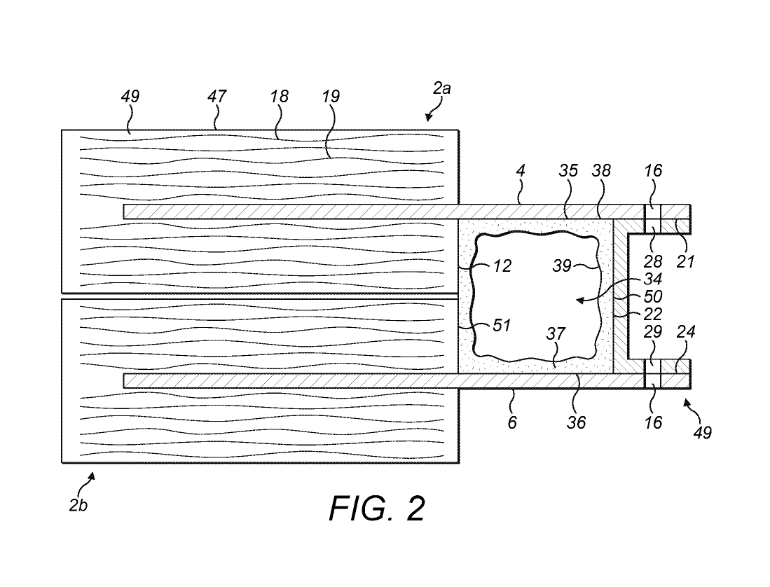

FIG. 2 is a schematic view of parts of the embodiment of FIG. 1 showing two electrical cells electrically connected to each other by way of an electrical connector contacting an electrical terminal of one electrical cell and an electrical terminal of another electrical cell;

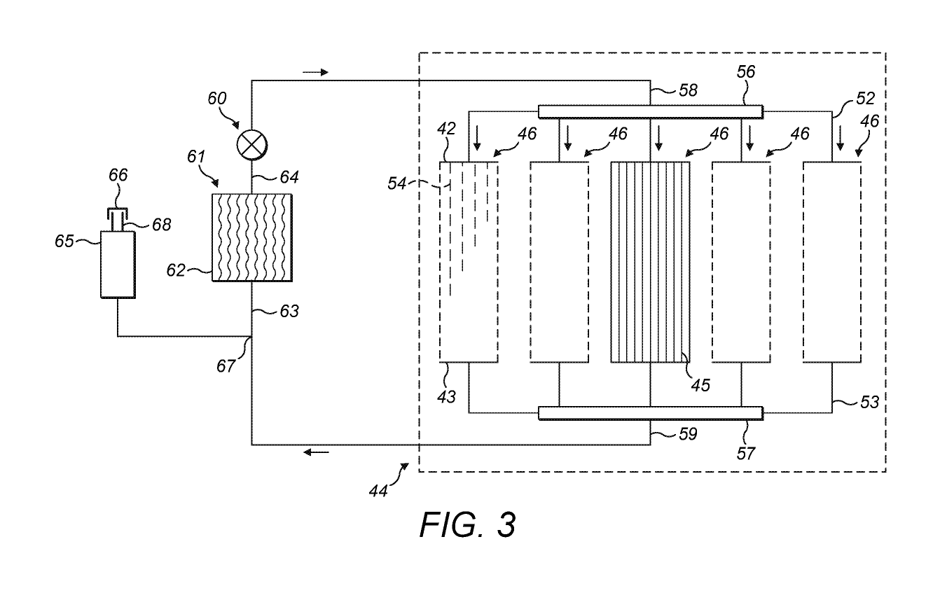

FIG. 3 is a schematic flow diagram of the system of FIGS. 1 and 2 with a fluid circuit, pump and heat exchanger, whereby the pump is configured to pump fluid around the fluid circuit, through a plurality of fluid conduit members and thereby cooling a number of electrical cells;

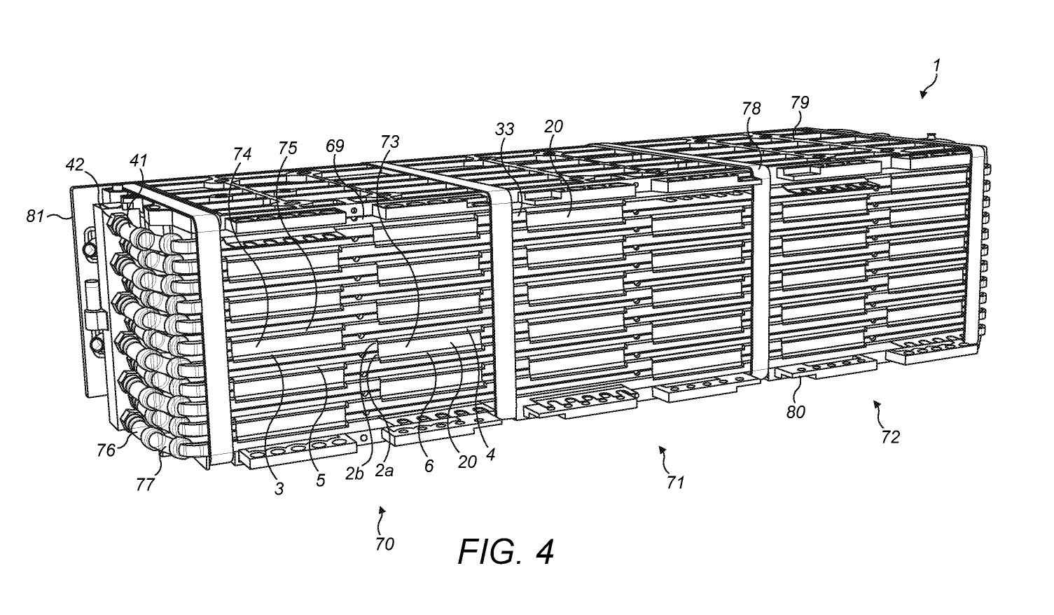

FIG. 4 is a perspective view of the components of the earlier figures in a battery pack assembly comprising a plurality of fluid pipes;

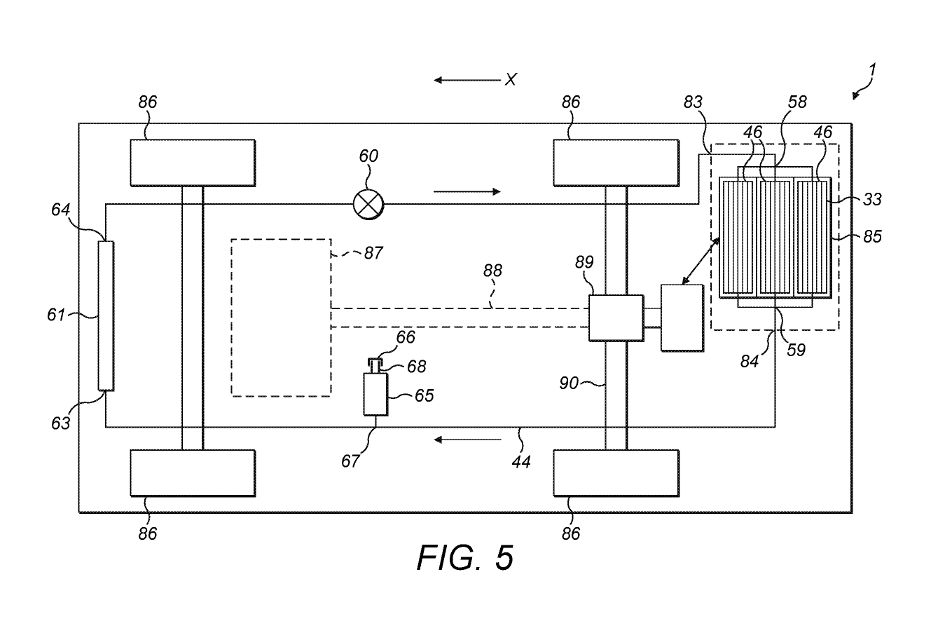

FIG. 5 is a schematic view of an automobile including the battery pack of FIG. 4;

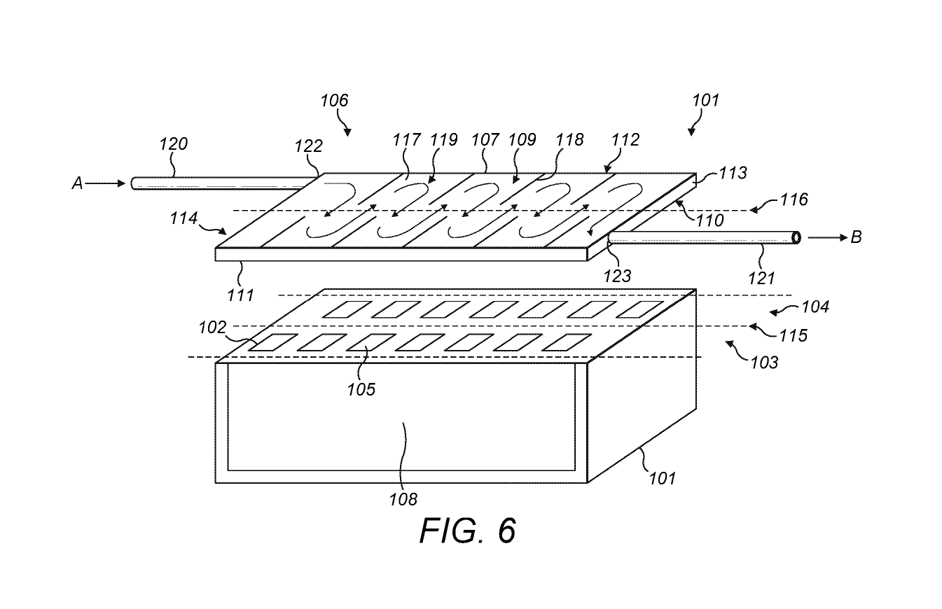

FIG. 6 is a schematic view of parts of a second preferred embodiment of a heat transfer system for transferring heat from electrical cells according to the present invention; and

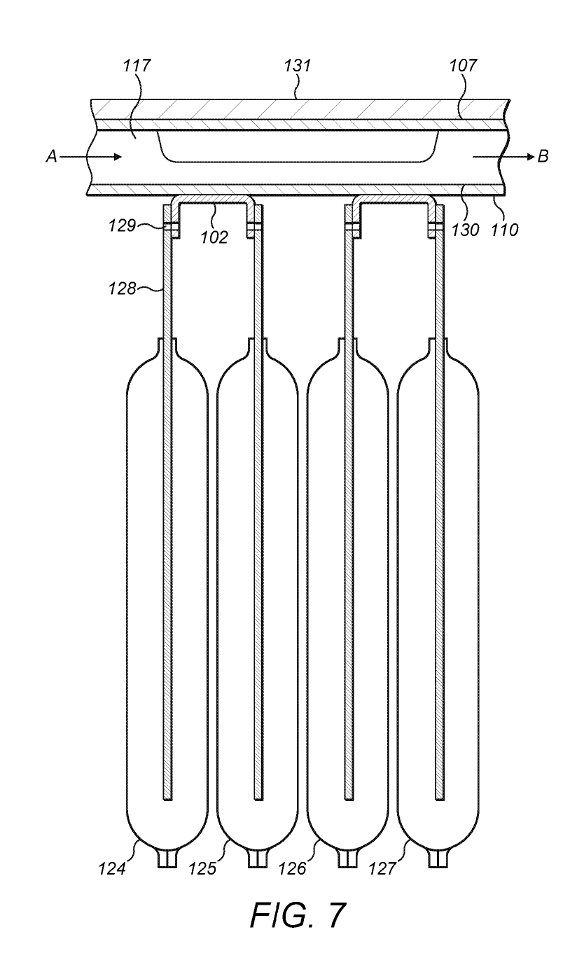

FIG. 7 is a schematic cross sectional view of the embodiment of FIG. 6.

Parts of a preferred embodiment of a heat transfer system 1 for transferring heat according to the present invention are shown in exploded view in FIG. 1. Two pouch type electrical cells 2a, 2b of a typical variety are shown, each having internal, interlaced and alternating electrodes, not shown for clarity, in the customary fashion and each having two external electrical terminals 3, 4; 5, 6 in electrical communication with their respective cell's internal electrodes. Embodiments in which one or more of the electrical cells 2a, 2b comprise only one electrical terminal or more than two electrical terminals are also envisaged. The electrical terminals 3, 4; 5, 6 may also be known as electrical connections as they may be used to electrically connect any number of electrical cells 2a, 2b together in series or in parallel.

The electrical cells 2a, 2b are substantially cuboid in shape such that each electrical cell 2a, 2b has two generally horizontally-orientated substantially flat and substantially parallel elongate top 7 and bottom 8 faces and four substantially narrower side faces 9, 10, 11, 12 which are generally vertically orientated and generally perpendicular to the two generally horizontally orientated top 7 and bottom 8 faces. In this way, the width and depth of each electrical cell 2a, 2b is substantially greater than its thickness. The four side faces 9, 10, 11, 12 are arranged in two pairs of generally opposing side faces 9, 11; 10, 12 and each of the four side faces 9, 10, 11, 12 are generally perpendicular to both of their adjoining side faces 9, 10, 11, 12. Both side faces of one pair of opposing side faces 9, 11 are generally of the same length and each side face of the other pair of side faces 10, 12 are generally of the same length as each other. One pair 10, 12 of said faces is shorter in length than the other pair 9, 11.

When charged, the electrical cells 2a, 2b are configured such that there exists an electrical potential difference between both of their electrical terminals 3, 4; 5, 6 such that one 4, 6 is substantially positively charged (herein referred to as the positive terminal) and such that the other 3, 5 is substantially negatively charged (herein referred to as the negative terminal) relative to the other electrical terminal 4, 6. The electrical terminals 3, 4; 5, 6 are therefore in electrical communication with their respective electrical cells 2a, 2b.

Both electrical terminals 3, 4; 5, 6 of each electrical cell 2a, 2b are substantially cuboid in shape and are substantially thin such that the bulk of the surface area of each terminal 3, 4; 5, 6 is substantially made up of substantially parallel and substantially flat top 13 and bottom 14 surfaces. These top 13 and bottom 14 surfaces may also be respectively referred to as upper 13 and lower 14 terminal surfaces. As such, each electrical terminal 3, 4; 5, 6 may be made from sheet metal or other such thin pre-formed material.

Each electrical terminal 3, 4; 5, 6 comprises two spaced-apart apertures 15, 16, each extending from each terminal's top surface 13 entirely through to each terminal's bottom surface 14. The apertures 15, 16 are substantially cylindrical and their longitudinal axes are substantially parallel to each other. The apertures 15, 16 of the electrical terminals 3, 4; 5, 6 act as part of a mounting means 26 configured to physically connect one terminal 4 of one electrical cell 2a to one terminal 6 of another electrical cell 2b. As such, when the connecting means 17 comprises one or more bolts, the apertures 15, 16 may comprise bolt holes sized to receive a bolt. In this arrangement, the internal cylindrical wall of the bolt holes 15, 16 may also be threaded to engage with the thread of a threaded bolt.

In FIG. 1, both of each electrical cell's terminals 3, 4; 5, 6 are arranged on one 12 of the side faces of each electrical cell such that they are aligned with the upper 7 and lower 8 flat surfaces of the terminals 3, 4; 5, 6 of one cell 2a being substantially parallel with the other cell's 2b terminal surfaces. In the embodiment shown, the electrical terminals 3, 4; 5, 6 are located on one 12 of the shortest of the four side faces or walls 9, 10, 11, 12 of their respective electrical cell 2a, 2b. The electrical terminals 3, 4; 5, 6 extend through this side wall 12 and are electrically connected to a plurality of internal electrodes 18, 19 within each electrical cell 2a, 2b. The electrical terminals 3, 4; 5, 6 are configured to be electrically conductive and so may be made from any substantially electrically conductive material, such as a metal, for example stainless steel or any other type of steel.

As well as being in electrical communication with their respective electrical cells 2a, 2b, the electrical terminals 3, 4; 5, 6 are also in thermal communication with their respective electrical cells 2a, 2b. In the embodiment shown, heat is transferred to the cell's terminals 3, 4; 5, 6 primarily through thermal conduction from the internal electrodes 18, 19 to the external electrical terminals 3, 4; 5, 6. Therefore, the electrical cells 2a, 2b may be heated up, for example in order to assist the electrical cells 2a, 2b in reaching an optimum operating temperature, or may be cooled down by supplying or extracting heat from one or all of the cell's electrical terminals 3, 4; 5, 6. Embodiments wherein only some or one of the electrical cells terminals 3, 4; 5, 6 are or is in thermal communication with their respective cell 2a, 2b are envisaged.

The two electrical cells 2a, 2b shown in FIG. 1 are arranged such that they are substantially vertically aligned with one substantially above and substantially parallel to the other, although any other orientation is envisaged. The electrical terminals 3, 4; 5, 6 of both electrical cells 2a, 2b face the same direction such that the apertures 15, 16 of the positive electrical terminal 4 of the upper electrical cell 2a are aligned with the apertures 15, 16 of the negative terminal 6 of the lower electrical cell 2b. Similarly, the apertures 15, 16 of the negative terminal 2b of the upper cell 2a are aligned with the apertures 15, 16 of the positive terminal 5 of the lower cell 2b and with the positive terminal of an electrical cell, not shown, above the upper electrical cell 2a. The upper 2a and lower electrical cells 2b may be referred to as first and second electrical cells 2a, 2b respectively.

An electrical connecting means 17 comprising a substantially U-shaped and elongate bracket 20 is arranged between the positive terminal 4 of the upper electrical cell 2a and the negative terminal 6 of the lower electrical cell 2b. The electrical connecting means 17 is configured to electrically connect terminals 3, 4; 5, 6 of the electrical cells 2a, 2b. The bracket 20 is U-shaped in cross-section, the U-shape being made up of three substantially flat walls 21, 22, 23, two of which 21, 23 are substantially parallel to each other and the other wall 22 extends between said two parallel walls 21, 23 at a distal edge 24, 25 thereof. Although in the example shown, the electrical connecting means 17 is a U-shaped bracket 20, it may also take the form of a number of other shapes, such as an S-shape or an E-Shape, wherein each branch of the E-Shape is configured to contact a different terminal 3, 4; 5, 6, such that the bracket may be configured to electrically connect a plurality of electrical cells 2a, 2b. Alternatively, the electrically connecting means 17 may comprise electrical clips contacting the electrical terminals, such as crocodile clips, or an electrical wire connecting the terminals 3, 4; 5, 6 in some other way, such as, for example, by the ends of the wire being soldered onto the respective terminals 3, 4; 5, 6.

In order to electrically connect the electrical terminals 3, 4; 5, 6, the electrically connecting means 17 comprises electrically conducting means such that electricity may be conducted form one terminal 6, to another 4. In this the embodiment shown, the bracket 20 comprises electrically conducting metal, however any other suitable form of electrically conducting material may be used. Additionally, the electrically connecting means 17 may comprise electrically conductive channels or circuits to thereby connect one or more electrical terminals 3, 4; 5, 6.

The bracket 17 comprises mounting means 26 which in the example shown comprises four cylindrical apertures 27, 28, 29, 30, two of which 27, 28 are located in and extend entirely through one of the substantially parallel walls 21 of the U-shaped electrically connecting bracket 20 and the other two apertures 29, 30 are located in and extend entirely through the other substantially parallel wall 23. The apertures 27, 28; 29, 30 of each wall 21, 23 are spaced apart so as to substantially correspond with the spacing of the apertures 15, 16 of the adjoining electrical terminal 2a, 2b. Therefore, the two apertures 27, 28 in the upper parallel wall 21 of bracket 20 are spaced apart to correspond with the spacing of the apertures 15, 16 in the positive terminal 4 of the upper electrical cell 2a, and the two apertures 29, 30 in the lower parallel wall 23 of the bracket 20 are spaced apart to correspond with the spacing of the apertures 15, 16 in the negative terminal 6 of the lower electrical cell 2b.

In the example shown in FIG. 1, the spacing of the apertures 15, 16 in the positive terminal 4 of the upper electrical cell 2a and the spacing of the apertures 15, 16 in the negative terminal 6 of the lower electrical cell 2b may be substantially the same so that the longitudinal axes of the apertures 27, 28 in one of the bracket's parallel walls 21 is substantially aligned with the longitudinal axes of the apertures 29, 30 in the other of the bracket's 20 parallel wall 23. In an embodiment in which an aperture 15, 16 of an upper cell's terminal 3, 4; 5, 6 is aligned with an aperture 15, 16 of the lower cell's terminal, a single bolt, not shown, may extend through one aperture 15 of the positive terminal of the upper cell, through the apertures 28, 29 of the connecting means 17, bracket 20, and through an aperture 15 of the negative terminal 6 of the lower cell 2b. In this scenario, the bolt may or may not be electrically conductive. If the bolt is electrically conductive, it is envisaged that the connecting bracket 20 could be made from an electrically insulating material because the bolt in this instance serves to electrically connect the two terminals 4,6.

The bolts may be replaced in other embodiments by other fasteners such as rivets.

Although the example of FIG. 1 only shows two electrical cells 2a, 2b, it can be envisaged that a plurality of electrical cells 2a, 2b could be electrically connected together, for example in series or in parallel. A series of electrical cells 2a, 2b electrically connected in series, such that the positive terminal 4 of one cell 2a is electrically connected to the negative terminal 6 of another cell 2b has the effect of increasing the voltage difference across the series of electrical cells 2a, 2b to the sum of the individual voltages produced by each cell 2a, 2b. To this end, as shown in FIG. 1, additional electrical connecting means 17, alternatively referred to as electrical conducing means 17, such as an additional electrical connector bracket 20, may be provided and which may be configured to electrically connect the other terminal (the negative terminal) 3 of the upper cell 2a to a positive terminal of a cell (not shown) above the upper cell 2a. Also shown in FIG. 1 is an additional electrically connecting means 20 comprising an additional electrical connector bracket 20 configured to electrically connect the positive terminal 5 of the lower cell 2b to a negative terminal of a further cell (also not shown) located below the lower cell 2b. In this way, a series of electrical cells 2a, 2b may be daisy-chained such that they are electrically connected in series to form a stack 31 of electrical cells 2, 3 producing an electrical voltage difference across the stack 31 equal to the sum of the individual voltage differences produced by each cell 2, 3. Similarly, it is envisaged that a series of electrical cells 2, 3 could also be electrically connected in parallel or that a plurality stacks 31 of electrical cells 2, 3, each stack 31 comprising a series of electrical cells 2, 3 electrically connected in series, could be connected in parallel. In a similar vein, a number of electrical cells 2, 3 connected in parallel could be electrically connected in series with another plurality of electrical cells 2, 3 connected in parallel. Accordingly, a plurality of electrical cells 2, 3 electrically connected in any combination is envisaged.

A heat transfer means 32 comprising a fluid conduit member 33, which, in the example shown, is in the form of a fluid pipe 33, is provided. The heat transfer means 32 is configured to enable heat to be transferred to or from the electrical terminals 3, 4; 5, 6 of the electrical cells 2a, 2b. As such, the fluid conduit member 33 of the heat transfer means 32 is configured to be in thermal communication with at least one of the electrical terminals 3, 4; 5, 6 and this is achieved by at least one external surface 38 of the fluid conduit member 33 directly contacting at least one of the electrical terminals 3, 4; 5, 6, although other ways of thermally connecting the fluid conduit member 33 with at least one of the electrical terminals 3, 4; 5, 6 are envisaged. Although direct contact of the external surfaces 38 of the fluid conduit member 33 is preferred, in other variations of the present invention the fluid conduit member 33 may not directly contact the terminals 3, 4; 5, 6, there being one or more layers of additional material therebetween. Such material could, for example, be substantially electrically insulating. Other parts of the heat transfer means 32 other than the fluid conduit member 33 itself may also directly contact one or more of the electrical terminals 3, 4; 5, 6.

In the example shown, the fluid conduit member 33 takes the form of a straight fluid pipe 33, a length of which is substantially square or rectangular in cross-section, comprising a fluid channel 34 which is also substantially square or rectangular in cross-section, as can be seen in FIG. 2. Other cross-sectional shapes of both the fluid conduit member 33 and the fluid channel 34 are envisaged, such as circular, triangular, trapezoidal, pentagonal, or hexagonal, and the cross-sectional shape may be a regular or irregular polygon and may vary over the length of the fluid conduit member 33. The fluid pipe 33 runs between the terminals 3, 4 of the upper cell 2a and the terminals 5, 6 of the lower cell 2b such that the upper surface 35 of the square cross-section fluid pipe 33 directly contacts the underside surface of the upper cell's 2a electrical terminals 3, 4 and the lower surface 36 of the square cross-section fluid pipe 33 directly contacts the upper surface of the lower cell's 2b electrical terminals 5, 6. Of course, other variations are envisaged where the fluid conduit member 33 does not contact all of the electrical terminals 3, 4; 5, 6 of each electrical cell 2a, 2b, but, for example, instead contacts only one terminal 3, 4; 5, 6 of only one cell 2a, 2b or contacts only one terminal 3, 4; 5, 6 of each cell 2a, 2b of a series of electrically connected electrical cells 2a, 2b, 31.

The fluid conduit member 33 comprises a substantially electrically insulating and substantially thermally conductive material 37, such as a polymer, for example Nylon, which serves to, and is configured to, electrically insulate the electrical terminals 3, 4; 5, 6 of each or different electrical cells 2a, 2b thereby ensuring that the electrical terminals 3, 4; 5, 6 are not electrically shorted. The fluid conduit member 33, or fluid pipe 33 in the example shown, comprises the substantially electrically insulating and substantially thermally conductive material 37 at least on the areas of the external surface 38 of the fluid conduit member 33 which directly contact the electrical cells 3, 4; 5, 6, and in this arrangement, the specific type of substantially electrically insulating and substantially thermally conductive material 37 directly contacting different electrical terminals 3, 4; 5, 6 may be different from one electrical terminal 3, 4; 5, 6 to another 3, 4; 5, 6, for example Nylon may be used on one area of the external surface 38 of the fluid pipe 33 to directly contact one terminal 3, 4; 5, 6 and a different substantially electrically insulating and substantially thermally conductive material 37 may be used on a different area of the external surface 38 of the fluid conduit member 33 to directly contact another electrical terminal 3, 4; 5, 6. The fluid conduit member 33 may also comprise boron, such as a boron filler, for example the internal surface of the fluid conduit member 33 may comprise boron.

Although the fluid conduit member 33, or fluid pipe 33 in the example shown, comprises substantially electrically insulating and substantially thermally conductive material 37 at least on the areas of the external surface 38 of the fluid conduit member 33 which directly contact the electrical cells 2a, 2b, the fluid conduit member 33 may also comprise this material elsewhere on its external surface 38 and the material 37 may completely cover the fluid conduit member's 33 external surface 38. Where the material 37 is situated on the external surface 38 of the fluid conduit member 33, spaced to correspond with the spacing of the electrical cell's 2a, 2b electrical terminals 3, 4; 5, 6 so that, once assembled, the material 37 directly contacts the terminals 3, 4; 5, 6, a length of this material 37 may also extend between these two patches to provide further electrical insulation between the terminals 3, 4; 5, 6 contacted by the material 37.

The substantially electrically insulating and substantially thermally conductive material 37 may also extend at least in one area, or multiple areas, of the fluid conduit member's 33 external surface 38 entirely through the external wall 38 of the fluid conduit member 33 to the interior surface 39 of the fluid conduit member 33 the interior fluid channel 34 therein. In the example shown, the fluid conduit member 33 is fabricated entirely from a single piece of substantially electrically insulating and substantially thermally conductive material 37 such that the material 37 forms both external 38 and internal 39 surfaces of the fluid conduit member 33 and the fluid conduit member's 33 thickness throughout its entire length.

The fluid conduit member 33 is configured such that one of its rectangular side faces 22 directly contacts the electrically connecting means 20. This configuration may assist in securing the fluid conduit member 32 in the correct position, for example by securing it against the side walls 12 of the electrical cells 2a, 2b, and may additionally assist in improving the thermal connection between the fluid conduit member 33 and the electrical terminals 3, 4; 5, 6 by providing a compressive force on the exterior walls of the fluid conduit member 38, causing them to bulge outwards and compress against the electrical terminals 3, 4; 5, 6.

The fluid channel 34 of the fluid conduit member 33 is configured to carry fluid along the fluid conduit member 33 in the direction of the fluid conduit member's 33 longitudinal axis. This fluid is configured to receive heat from the electrical terminals 3, 4; 5, 6 of the electrical cells 2a, 2b such that, in use, as the electrical cells 2a, 2b increase in temperature, heat is conducted to the electrical terminals 3, 4; 5, 6, through the exterior walls 38 of the fluid conduit member 33, through its thickness and to its interior wall 39. By fluid flowing along the fluid conduit member's 33 fluid channel 34, heat is thereby transferred primarily by conduction and forced convection to the fluid itself and so heat is carried away from the electrical terminals 3, 4; 5, 6. This serves to cool the electrical terminals 3, 4; 5, 6 and thereby the electrical cells 2a, 2b to prevent them from overheating or to maintain them at a desired or predetermined operating temperature.

As will be appreciated, the principle of this system could be operated in reverse such that heat was transferred from the fluid in the fluid channel 34 to the electrical terminals 3, 4; 5, 6 and thereby enable the electrical cells 2a, 2b to reach an optimum or predetermined temperature more quickly than would otherwise be the case.

The fluid with the fluid channel 38 is preferably of a high heat capacity and is at least partially thermally conductive so that heat may be efficiently transferred from the inside walls 39 of the fluid conduit member 33 to the fluid inside. A high heat capacity enables the fluid to absorb more heat without the temperature of the fluid increasing substantially. For this reason, water may be used.

Additionally, the fluid within the fluid channel 34 may be, or comprise, a fluid retardant or suppressant. In this case, the heat transfer means 32 may be configured to release the fire suppressant or retardant onto or into the vicinity of the electrical cells 2a, 2b when a predetermined temperature is reached. This temperature may be the temperature of any part of any component of the heat transfer system 32, and may in particular be the temperature of an electrical cell 2a, 2b, one of its external surfaces 7, 8, 9, 10, 11, 12, an electrical terminal 3, 4; 5, 6, a fluid conduit member 33, or the fluid within the fluid channel 34.

A sensor may be provided and may be configured to measure this temperature and a control system may be provided to read the output of the temperature sensor and to cause the fluid within the fluid channel 34 to be released.

Alternatively or additionally, a fluid conduit member 33 may be configured to perforate or burst, or to fail in some other way, upon the predetermined temperature being reached so as to release the fluid, and thereby fire suppressant or retardant, onto or into the vicinity of one or more electrical cells 2a, 2b.

In the example shown, the fluid conduit member 33 comprises a single fluid channel 34. Other variations of the present invention are envisaged wherein the fluid conduit member 33 comprises a plurality of fluid channels 34 which may be configured such that fluid may flow in different directions along different fluid channels 34 of the fluid conduit member 33. For example, in an embodiment wherein the fluid conduit member 33 comprises two channels 34, fluid may flow from left to right in one fluid channel 34 while fluid in the other fluid channel 34 may flow from right to left. In this way, a cross-flow heat transfer means could be provided.

Additional fluid conduit members 40, 41 are fluidly connected to the fluid channel 34 of the first fluid conduit member 33 at either end of the first fluid conduit member 33. Fluid conduit member 40 provides fluid to fluid conduit member 33 and therefore may be referred to as an inlet fluid conduit member 41. Similarly, fluid conduit member 41 receives fluid from fluid conduit member 33 once it has received heat from terminals 3, 4; 5, 6 and therefore may be referred to as an outlet fluid conduit member 41.

These additional fluid conduit members 40, 41 may be integrally formed with the first fluid conduit member 33. A fluid conduit connecting means, not shown, may alternatively be provided to fluidly connect the first fluid conduit member 33 to one or both of the additional fluid conduit members 40, 41. Each of these additional fluid conduit members 40, 41 are then fluidly connected to substantially vertical pipes 42, 43, or plenums, each comprising a fluid channel 34. One of the vertical pipes, the fluid inlet plenum 42, is fluidly connected to a fluid inlet, not shown, configured to supply fluid to the fluid inlet plenum 42. The other vertical pipe, the fluid outlet plenum 43, is fluidly connected to a fluid outlet, not shown, configured to receive fluid from the fluid outlet plenum 43. In use, a pressure difference between the fluid inlet plenum 42 and the fluid outlet plenum 43 causes fluid from a fluid circuit 44 to flow from the fluid inlet plenum 42, through the fluid path formed by the first fluid conduit member 33 and the additional fluid conduit members 40, 41, to the fluid outlet plenum 43. It can therefore be seen that the fluidly connected first fluid conduit member 33 and additional fluid conduit members 40, 41 form a branch 45 of a fluid circuit 44 and that a plurality 46 of these branches 45 could be fluidly connected in parallel to the inlet 42 and outlet 43 plenums along their length to form a parallel fluid circuit, each branch 45 being configured to transfer heat to or from an electrical cell 2a, 2b. Fluid conduit members 40, 41 or branch 45 may be referred to as a heat transfer duct.

FIG. 2 shows a schematic section view of the heat transfer system 1 of FIG. 1, the section view being taken through a plane extending through the positive terminal 4 of the upper cell 2a and the lower terminal 6 of the lower cell 2b and showing, in section, the upper electrical cell 2a and its positive terminal 4, the lower electrical cell 2b and its negative terminal 6, the fluid conduit member 33 and fluid channel 34, the electrical connecting means 20 in the form of a bracket, connector, or interconnector 20, and a fastener configured to fasten the bracket 20 to the upper electrical cell's 2a positive terminal 4 and to the lower electrical cell's 2b negative terminal 6.

The electrical cells 2a, 2b are of the typical pouch variety and therefore may be called a pouch type cell, although any other suitable type of electrical cell could be used and different types of electrical cell could be used concurrently. A laminated film pouch 47 forms the exterior body of each electrical cell 2a, 2b, the laminated film pouch 47 containing a plurality of interlaced and alternating-polarity leaf electrodes 18, 19, with a separator layer 48 separating the alternating-polarity leaf electrodes 18, 19, and an electrolyte solution 49. An electrical connection or terminal 4, in electrical communication with one polarity of electrodes, in this example the positive electrodes 18, extends from the inside of the electrical cell 2a to the outside by passing through one of the electrical cell's side walls 12. Another electrical cell terminal 3, not shown, is in electrical communication with the negative electrodes 19. In the example shown, the upper terminal 4 is in electrical communication with, and may be directly connected to, the positive electrodes 18 inside the electrical cell 2a and therefore the upper electrode 4 is configured to have a positive polarity when the electrical cell 2a is sufficiently charged. The lower terminal 6 is in electrical communication with, and may be directly connected to, the negative electrodes 19 inside the lower electrical cell 2b and therefore the lower terminal 6 is configured to have a negative polarity when the electrical cell 2b is sufficiently charged. The electrical terminals 3, 4; 5, 6 of the upper 2a and lower 2b cells are therefore in thermal and electrical communication with their respective electrical cells 2a, 2b, and the electrodes 18, 19 therein, and therefore heat produced by the chemical reaction inside the electrical cells 2a, 2b is conducted from the inside of each electrical cell 2a, 2b and the components therein 18, 19, 48, 49 to the electrical terminals 3, 4; 5, 6 on the outside of the cells 2a, 2b.

An interconnector in the form of a U-shaped electrically-conductive bracket 20 comprises the electrically connecting means 20 configured to electrically connect one electrical terminal 4 to another 6. In the embodiment shown, the connecting means 20 is configured to electrically connect the positive terminal 4 of the upper cell 2a to the negative terminal 6 of the lower cell 2b by the upper 21 and lower sides 23 of the bracket 20 physically and directly contacting the upper 4 and lower 6 terminals respectively to thereby form an electrical bridge between them. In this way, the upper cell 2a and lower cell 2b are electrically connected together in series.

The terminals 3, 4; 5, 6 of the upper 2a and lower 2b electrical cells comprise fastening means 49 in the form of substantially cylindrical apertures 16 extending entirely through the thickness of the terminals 4, 6, from one surface of the terminal to the other, generally opposing surface of the terminal. For clarity, only one of the apertures 16 in each terminal 4, 6 is shown. The parallel sides of the U-shaped interconnector 21, 24 each comprise apertures 28, 29 configured to align with the longitudinal axes of the upper 4 and lower 6 terminal apertures 16 such that a fastening member, not shown, can be used to fasten the terminals 4, 6 to the interconnector 20, for example by providing a fastening member, for example a bolt, within one or both of the apertures 15, 16 of one terminal and within the corresponding apertures 27, 28; 29, 30 in the interconnector 20. In the case where a threaded bolt is used, the cylindrical internal surface of one of the apertures 15, 16 in one of the terminals 4, 6 or the interconnector 20 could be threaded to receive and engage with the thread of the bolt. Alternatively a threaded nut could be used to engage the bolt and secure the electrical terminals 4, 6 to the interconnector 20. Other fastening means configured to fasten an electrical terminal 4, 6 to an electrically connecting means 20 are envisaged, such as clamps or an adhesive.

A fluid conduit member 33 is provided in the area bound between the positive terminal 4 of the upper electrical cell 2a, the adjoining face 22 of the U-shaped interconnector 20, the negative terminal 6 of the lower electrical cell 2b, and the side face 12 of each electrical cell 2a, 2b. The fluid conduit member 33 comprises a fluid channel 34, carrying coolant, which runs longitudinally into the plane of the diagram.

The fluid conduit member 33 is of the form of a square-section tube or pipe. One of the sides 35 of the square-section directly contacts the underside of the upper positive terminal 4, another side 36 directly contacts the top external surface of the lower negative terminal 6, another 50 directly contacts the adjoining face 22 of the U-shaped interconnector 20 and the remaining side face 51 contacts a side wall 12 of both of the electrical cells 2a, 2b.

The walls 35, 36, 50, 51 of the fluid conduit member 33 are fabricated entirely from a single piece of substantially thermally conductive and substantially electrically insulating material 37, such as a polymer, with a fluid channel 34 extending therebetween. The internal walls 39 of the fluid conduit member 33 are substantially rough and irregular in order to increase the effective area of material available for heat conduction and thereby may increase the total rate of the heat transfer to the fluid therein. Rough or irregular walls may also increase fluid turbulence within the fluid channel to thereby promote mixing of the fluid within the channel to assist with heat dissipation and to more evenly heat the fluid. Other variations are envisaged wherein the material 27 of the fluid conduit member 33 extends into the fluid channel 34 in the form of a web or a honeycomb-like matrix in order to further increase the rate of heat transfer to the fluid.

A fluid circuit diagram of the heat transfer system is shown in FIG. 3. Five groups 46 of fluid conduit members 33 are shown, each group comprising a plurality of fluid conduit members 45 fluidly connected in parallel to a common inlet channel 52 and a common outlet channel 53. For clarity, the individual fluid conduit members 45 are shown only in the central group, and are shown as vertical dashed lines 54 in the far group 46 on the far left of the diagram. Each group 46 of fluid conduit members 33 is arranged to contact the electrical terminals 3, 4: 5, 6 of a stack of electrically connected electrical cells 2a, 2b as described with reference to earlier drawings. The electrically connected electrical cells 2a, 2b collectively form a battery having a battery case 55 provided for safety and to electrically isolate the electrical cells 2a, 2b therein from external bodies. The battery case may be, for example, as described in GB2505871. For clarity, the stacks of electrical cells 2a, 2b are shown only in outline but it will be understood that the cells 2a, 2b of each stack are arranged such that their electrical terminals 3, 4; 5, 6 are in direct contact with the fluid conduit members 33 of each group 46 of fluid conduit members.

Each group 46 of fluid conduit members 33 connected in parallel are themselves fluidly connected in parallel to a secondary common inlet plenum, or inlet coolant manifold, 56 and a secondary common outlet plenum, or outlet coolant manifold, 57 such that fluid may flow from an inlet channel 58 of the secondary inlet plenum 56, through the secondary inlet plenum 56, through each of the common inlet channels 52, though each primary inlet plenum 42 before then being passed through each individual fluid conduit member 33 of each group 46. The fluid then exits each individual fluid conduit member 33 of each group 46, passing then through the primary outlet plenum 43 of that group 46 and joining at a common outlet channel 53, common to each group, before then passing through the secondary outlet plenum 57 where all five common fluid outlet channels 53 join together to flow through a common outlet channel 59 of the secondary outlet plenum 57.

The outlet channel 59 of the secondary outlet plenum 57 is fluidly connected to the inlet channel 58 of the secondary inlet plenum 56 to form a fluid circuit 44.

The fluid circuit 44 comprises a pump means, such as a pump 60, fluidly connected in series with the fluid circuit 44 and is configured to pump fluid through the fluid circuit 44 and thereby through each of the individual fluid conduit members 33 of each fluid conduit group 46.

A heat exchanger 61, such as a radiator, is provided fluidly connected in series with the fluid circuit 44 by fluid inlet 63 and fluid outlet 64. The heat exchanger 61 is configured to receive heated fluid from the outlet channel 59 of the secondary outlet plenum 57 and to dissipate its heat to a heat sink, which is not shown for clarity but which may be air, such as ambient air, which may pass over the heat exchanger 61. The heat exchanger 61 may comprise a plurality of fluid channels 62 fluidly connected in series or in parallel in order to increase the effective surface area of the heat exchanger 61 and thereby to increase the rate at which heat is dissipated from the fluid. Once cooled, the fluid exits the heat exchanger 61 through a single fluid conduit 64 and then flows onwards directly towards the pump 60.

Although not shown, a heating means may be provided to supply heat to fluid within the fluid circuit to enable heat to be transferred to the terminals of the electrical cells 3, 4; 5, 6. In one embodiment, the heating means may comprise a heat exchanger 61 configured to supply heat to the fluid.

A fluid fill tank 65 with cap 66 is provided at a fluid T-junction immediately upstream of the heat exchanger 61 and downstream of the secondary plenum outlet channel 59. The fluid fill tank 65 provides a means of refilling fluid within the fluid circuit 44 which may have escaped from the system, for example through a leak or as a result of draining the system for maintenance. In order to replenish the fluid, the fluid fill tank cap 66 is removed and fluid is supplied to the fluid fill tank 65 through a neck 68 of the fluid fill tank. The fluid fill tank 65 may comprise fluid level indicating means configured to indicate the volume of fluid within the system and this may comprise a float or graduated lines on a wall of the fluid fill tank 65.

FIG. 4 shows that the heat transfer system has a plurality of stacks of electrical cells 69, which may be the same as those of the earlier drawings or similar, cooled by a plurality of fluid conduit members 33.

Three stacks 70, 71, 72 of electrical cells are shown, with the electrical cells 69 of each stack being electrically connected in series by a plurality of electrical connecting means 20 in the form of U-shaped brackets 20. Stacks 70, 71, 72 wherein the stack's electrical cells 69 are individually electrically connected in parallel are also envisaged. Each stack 70, 71, 72 may be electrically connected in series with its adjacent stack 70, 71, 72 such that the total voltage of the combination of the three stacks 70, 71, 72 is the sum of the voltage produced by each of the three electrical stacks 70, 71, 72. Alternatively, the stacks 70, 71, 72 may be electrically connected in parallel such that the total voltage of all three stacks 70, 71, 72 is the total voltage of a single stack. Although the example shows three stacks 70, 71, 72, any number is envisaged, whether electrically connected to each other or physically located substantially next to each other.

Each electrical cell 69 is electrically connected in series to the immediately adjacent cell or cells by an electrically connecting means 20 in the form of a U-shaped bracket 20 which directly contacts the electrical terminals 3, 4; 5, 6 of adjacent cells to bridge the gap between them. In the example shown, electrically conductive U-shaped bracket 73 contacts and electrically connects the negative terminal 6 of the lower electrical cell 2b and the positive terminal 4 of the electrical cell immediately above 2a, hereunder referred to as the second cell or upper cell, to thereby electrically connect both electrical cells 2a; 2b in series. A fastening means, not shown, is provided to secure the bracket 20 to the positive terminal 4 of the upper cell and the negative terminal 6 of the lower electrical cell.

A second electrically connecting means 74, in the form of an electrically conductive U-shaped bracket 74 similar to bracket 20 is provided such that the negative terminal 3 of the upper electrical cell 2a is electrically connected in series to the positive terminal of the cell 75 immediately above the upper cell 2a. By directly contacting the respective terminals, the U-shaped bracket 75 electrically connects the negative terminal 3 of the upper electrical cell 2a to the positive terminal of the cell 75 immediately above cell 2a.

Additional electrically connecting means 74 in the form of electrically conductive U-shaped brackets 74 are provided between the remainder of the cells in the first stack such that each of the electrical cells 69 in the first stack 70 are electrically connected in series. The electrical cells 69 of the other two stacks 71, 72 are connected in series in a similar way.

An inlet plenum 42 is located on the left hand side of FIG. 4 from which eleven fluid conduit members 33 extend and to which the eleven fluid conduit members 33 are fluidly connected. An outlet plenum, fluidly connected to the eleven fluid conduit member 33 is located on the right hand side of the diagram but this is obscured by the electrical cell stack 72 at that end.

Eleven fluid conduit members 33, each comprising a fluid conduit 34, extend from the inlet plenum 42 and are fluidly connected to it in parallel with each other. These fluid conduit members 33 are shown as being transparent for clarity and they may or may not comprise substantially thermally conductive and substantially electrically insulating material. A fluid connection means 76 is provided at the interface of the fluid conduit members 41 and the inlet plenum 42 to enable the fluid connections between each fluid conduit member 33 and the inlet plenum 42. The fluid conduit members 41 that are directly connected to the inlet plenum 42, which may also be called the inlet fluid conduit members 41, are relatively short and are fluidly connected in series to a second fluid conduit member 33 which is of a longer length than the inlet fluid conduit member 41 connected to the inlet plenum 42. These second, longer fluid conduit members 33 also comprise an internal fluid conduit 34. A second fluid connection means 77 is provided at the interface between the inlet fluid conduit member 41 and the longer fluid conduit member 33 to provide a fluid connection between them.

The second, longer fluid conduit members 33 extend substantially along the length of all three stacks 70, 71, 72 of electrical cells 69 and along a side face 12 thereof. These fluid conduit members 33 are arranged such each fluid conduit member 33 runs along a different row of electrical cells 69 along the combined length of the three stacks 70, 71, 72. One of each of these second fluid conduit members 33 is located between the terminals 3, 4; 5, 6 of each row of electrical cells 69 and they are located such that they run in between the gap formed by the U-shaped electrical connecting brackets 20, 74 and the side faces 12 of the electrical cells 69.

The longer fluid conduit members 33 are made from a single piece of substantially thermally conductive and substantially electrically insulating material 27. The external surface 35, 36, of these fluid conduit members 33 directly contacts the electrical terminals 3, 4; 5, 6 of the electrical cells 69 immediately above and below each row of fluid conduit members 33. The substantially thermally conductive and substantially electrically insulating material 27 of each fluid conduit member 33 therefore extends continuously from one electrical terminal 3, 4; 5, 6 to the next, across not only the adjacent electrical terminals 3, 4; 5, 6 of each stack 70, 71, 72 of electrical cells 69, but also continuously across all of the electrical terminals 3, 4; 5, 6 of all three stacks 70, 71, 72 of electrical cells 69. In this way, each fluid conduit member 33 may bridge across adjacent stacks 70, 71, 72 of electrical cells 69 in order to extract heat from a number electrical cells 69 which are not directly electrically connected in series. As the material 27 which contacts the electrical terminals 3, 4; 5, 6 is substantially electrically insulating, the fluid conduit members 33 are able to extract heat from a plurality of electrical cells 69 by directly contacting their electrical terminals 3, 4; 5, 6 without electrically shorting them or affecting the combined voltage of the stacks 70, 71, 72 of electrical cells 69.

At the end of each of the longer fluid conduit members 33, and so at the end of the three stacks of electrical cells 70, 71, 72, each of the longer fluid conduit members 33 is fluidly connected to a third set of shorter fluid conduit members, which may also be called outlet fluid conduit members 41, by a fluid connection means, not shown, similar to that described above. These outlet fluid conduit members 41 and fluid connection means are obscured by the stack 72 of electrical cells 69 at the far end of the group of stacks. The outlet fluid conduit members are then fluidly connected by another fluid connection means similar to the fluid connection means 76, 77 to an outlet plenum 43 which is also obscured by the distal stack 72 of electrical cells 69.

Tensioned ribbons 78 act as a retaining means to maintain the assembly of electrical stacks 69 by providing a compressive force against top 79 and bottom 80 palettes which serve to distribute the compressive force of the ribbons 78 evenly along the surface of the uppermost and lowermost row of electrical cells 69. The palettes 79, 80 may also serve to protect the stacks of electrical cells 70, 71, 72 from impact or other external forces. The retaining means 78 may also comprise tensioning means configured to enable tension to be applied to and released from the ribbons 78 to facilitate with assembly and disassembly of the stacks 70, 71, 72 of electrical cells 69 and the heat transfer system 1 generally.

A back plate 81 forms one side of a battery case 55. For clarity, the other sides of the battery case are not shown. The back plate 81 comprises an inlet and an outlet fluid connection, fluidly connected to the plurality of fluid conduit members, to enable the battery to be easily connected to a fluid circuit which may comprise a pump 60 and heat exchanger 61 such as those shown in FIGS. 3 and 4.

An automobile 82 comprising the heat transfer system 1 is shown in FIG. 5. The intended direction of travel of the automobile is indicated by arrow X. Three groups of fluid conduit members 46 are arranged fluidly connected in parallel with each other, each group 46 comprising a plurality of fluid conduit members 33 fluidly connected in parallel to each other. Each fluid conduit member 33 is in thermal communication with at least one electrical cell 69, wherein, for clarity, the electrical cells are not shown. The electrical cells 69 of each stack may be electrically connected in parallel or in series with each other to form an electrical stack 70, 71, 72 and each electrical stack may be connected in parallel or in series with each other.

A broken line marks the boundary of an electrical battery case 55 comprising the groups 46 of fluid conduit members 33 and stacks 70, 71, 72 of electrical cells 69. The electrical battery case 55 comprises a common fluid inlet 83 and a common fluid outlet 84 to which the plurality of groups 46 of fluid conduit members 33 are fluidly connected. The fluid network of fluid conduit members 33 is fluidly connected to a fluid circuit 44 by way of a common fluid inlet 58 and a common fluid outlet 59.

A pump 60 is fluidly connected in series with the fluid circuit 44 and is configured to pump fluid through the network 85 of fluid conduit members 33 and around the remainder of the fluid circuit 44.

A fluid fill tank 65 with cap 66 is provided at a T-junction 67 immediately downstream of the network 85 of fluid conduit members 33. The fluid fill tank 65 provides a means of refilling fluid within the fluid circuit 44 which may have escaped, for example through a leak or as a result of draining the system for maintenance. In order to replenish the fluid, the fluid fill tank cap 66 is removed and fluid is supplied to the fluid fill tank 65 through the fluid fill tank neck 68. The fluid fill tank 65 may comprise fluid level indicating means configured to indicate the volume of fluid within the system and this may take the form of a float or graduated lines on a wall of the fluid fill tank 65.

A heat exchanger 61, such as a radiator, is provided substantially towards one side of the automobile 82. In this example, the heat exchanger is provided substantially towards the front of the automobile 82, but may also be provided at the rear or on one side such as in a wing or pod of the automobile or car, or in any other position of the automobile 82.

The heat exchanger 61 is fluidly connected in series with the fluid circuit 44 by a fluid inlet 63 and a fluid outlet 64 and it is configured to dissipate heat from the fluid in the fluid circuit which has been collected from the electrical cells 69 in thermal communication with the fluid conduit members 33 of the network 85 of fluid conduit members 33.

The electrical cells 69 may be electrically connected to one or more electrical motors 90 (motor generators) configured to drive one or more of the wheels 86 of the automobile 82. An energy recovery means, here in the form of a motor generator 90, may be provided to enable the kinetic energy of the automobile 82 or of a flywheel to be used to charge the electrical cells 69, as shown by the doubled-headed arrow between the motor generator 90 and the electrical cells 69. The electrical cells 69 may also be electrically connected to an engine 87 of the automobile 82 wherein the engine 87 could be configured to electrically charge the electrical cells 69. In this example, the engine 87 is shown in a two wheel drive rear wheel drive system wherein the engine 87 is mechanically connected to a drive shaft 88 which is itself mechanically connected to a differential 89, which is then in turn connected to a rear axle 90 and thereby to two rear wheels 86. Other variations of power delivery are similarly envisaged such as front wheel drive or four-by-four, or any other combination of drive of an automobile with any number of wheels.

Parts of a second preferred embodiment of a heat transfer system 100 for transferring heat from at least one electrical cell according to the present invention are shown in the schematic view of FIG. 6. A support frame or housing 101 contains a stack 108 of electrical cells 124, 125 126, 127, arranged back-to-back. For clarity, the electrical cells 124, 125, 126, 127 are not shown.

Each electrical cell 124, 125, 126, 127 is a pouch type cell and comprises two electrical terminals 128 configured such that, in use, an electrical voltage, or potential difference, exists across the two terminals 128 of each cell 124, 125, 126, 127.

The electrical cells 124, 125, 126, 127 are electrically connected in series to thereby provide a combined voltage across the stack 108 which is greater than the individual voltage produced by any one cell 124, 125, 126, 127. In the example shown, an electrical connecting means in the form of a U-shaped electrical interconnector or bridge 102 electrically connects the electrical cells 124, 125, 126, 127 sequentially in the order in which they are stacked such that the U-shaped brackets 102 connect the positive terminal 128 of one cell 124, 125, 126, 127 to the negative terminal 128 of the adjacent electrical cell 124, 125, 126, 127 in the stack 108 of electrical cells 124, 125, 126, 127. The electrical interconnector 102 is the same as that of the first embodiment of the present invention and as such comprises or is manufactured from electrically conductive material, such as copper or aluminium. The interconnector 102 may alternatively comprise a wire or any other such suitable means of electrically connecting the electrical cells 124, 125, 126, 127.

Although, in the example shown, the electrical cells 124, 125, 126, 127 are electrically connected by an interconnector or bracket 102, the terminals 128 of the electrical cells 124, 125, 126, 127 may also be arranged such that they directly contact the electrical terminals 128 of the adjacent electrical cell or cells 124, 125, 126, 127. In this regard, one or both of the electrical terminals 128 of each cell 124, 125, 126, 127 may be configured so as to bridge across, either entirely or only partway across, to the adjacent cell 124, 125, 126, 127, for example the electrical terminals 128 be substantially L-shaped such as to directly contact an electrical terminal 128 of an adjacent cell 124, 125, 126, 127. As the electrical terminals 128 may act as electrical connectors or an electrical connecting means between cells, they may also be considered to be electrical connectors.

As the electrical terminals 128 of each electrical cell 124, 125, 126, 127 are generally spaced apart, the electrical connecting means (which may also be referred to as the electrical connector, interconnector or bracket) 102, are shown in two rows 103, 104 with the interconnectors 102 of each row 103 being staggered with respect to the interconnectors 102 of the other row 104 and with the interconnectors 102 being generally equidistant in each row 103, 104 and equidistant across rows 103, 104 (although the distance between connectors 102 in each row may be different to the distance between connectors 102 between the rows 103, 104).

The U-shaped electrical connectors 102 are arranged such that the planar top surface 105 of the U-shaped electrical connectors 102 are generally co-planar with respect to each other such that the top of the interconnectors 102 are generally at the same height. Although, the interconnectors 102 are generally at the same height as each other, the dimensional variations between electrical cells 124, 125, 126, 127, for example due to manufacturing tolerances and particularly due to variation in thermal expansion of the pouches due to different operating temperatures of the cells 124, 125, 126, 127 and due to variations in the fill-weight of each cell 124, 125, 126, 127, may cause at least some of the electrical interconnectors 102 to be at different height to the others. The difference in height between the electrical connectors 102 may vary in use due to the variation in thermal expansion of each electrical cell 124, 125, 126, 127, for example as the electrical load on the cell 124, 125, 126, 127 increases, and also between electrical cells 124, 125, 126, 127, for example due to variations in the temperature of individual cells 124, 125, 126, 127 across the stack 108.

A heat transfer means 106 comprising a cooling bladder 107, which may also be referred to as a pouch, or bag, is shown in exploded view as being arranged above the stack 108 of electrical cells 124, 125, 126, 127. When assembled, the bladder 107 is arranged over the top of the stack 108 of electrical cells 124, 125, 126, 127 such that the bladder 107 directly contacts the upper surface 105 of each of the U-shaped electrical brackets 102. In some examples, for example those where an interconnect 102 is not used, the bladder 107 may be arranged to directly contact the terminals 128 of the cells 124, 125, 126, 127, for example where the electrical terminals 128 are L-shaped or where the terminals 128 are otherwise arranged such that they are generally co-planar with respect to each other, such as in examples where the electrical cells 124, 125, 126, 127 are arranged side-by-side, as opposed to back-to-back as in the example shown.

The bladder 107 is substantially planar, comprising a generally planar top 109 and bottom (or underside) 110 surface. Although in the example shown, the bladder 107 is substantially cuboid in shape, examples where the bladder 107 is any other suitable shape is also envisaged. Additionally, as the bladder 107 is substantially flexible, although the bladder 107 is generally cuboid, it may conform or adapt to a generally different shape for example as a result of internal pressurisation of the bladder 107 or as a result of the bladder 107 contacting surrounding surfaces.

As the bladder 107 is generally cuboid in shape, it comprises a substantially planar upper surface 109, a substantially planar lower surface 110, first 111 and second 112 longitudinal side faces and first 113 and second 114 lateral side faces.

The width of the bladder 107 is such that it is generally the same or greater than the combined width of the two rows 103, 104 of electrical connectors 102. Similarly, the length of the bladder 107 is such that it is generally the same or greater than the combined length of the two rows 103, 104 of electrical connectors 102. Thus, the bladder 107 is sized such that its underside surface 110, which contacts the electrical connectors 102 and acts as a heat transfer surface for transferring heat to or from the electrical cells 124, 125, 126, 127, is sufficiently large so as to be able to contact all of the electrical connecting brackets 102 or terminals 128 in the stack 108. The bladder 107 is orientated such that the length of the bladder 107 is generally parallel to the length of the electrical stack 108 and the longitudinal centreline 116 of the planar bladder 107 is generally aligned with the longitudinal centreline 115 of the stack 108 or electrical terminals 128 (i.e. the bladder 107 is arranged and aligned over the centre of the stack 108).

The bladder 107 is configured to contain fluid, such as a coolant, which may be the same or similar to that used in the first embodiment of the present invention. The bladder 107 comprises an internal fluid chamber 119 comprising an internal fluid channel 117.

In this example, the internal fluid channel 117 is configured such that it passes within, along and through the bladder 107 in a circuitous path. In particular, the internal fluid channel 117 is arranged such that, when the bladder 107 is arranged over the electrical stack 108, it passes sequentially along the electrical stack 108, passing successively between each electrical connector 102 and in the order in which the electrical cells 124, 125, 126, 127 are electrically connected. Thus, as the fluid channel 117 passes along the length of the bladder 107, it also passes from side-to-side across the width of the bladder 107, and as such may be said to zig-zag or snake within the bladder 107.

Although in this example the bladder 107 comprises a single internal fluid channel 117, other examples wherein the bladder 107 comprises a plurality of internal flow channels or passages 107 are also envisaged. For example, counterflow arrangements and other such suitable arrangements are also envisaged, including examples wherein the bladder 107 comprises a plurality of parallel fluid channels 117. Examples include wherein one of the fluid channels 117 is arranged so as to be able to receive heat from some of the electrical terminals 128 and another of the parallel fluid channels 117 is arranged so as to be able to receive heat from others, for example where one fluid channel 117 is arranged so as to be able to receive heat from the electrical connectors 102 or terminals 128 on one side of the stack 108, for example by the fluid channel 117 being thermally coupled with those connectors 102 or terminals 128, and another fluid channel 117 is arranged so as to be able to receive heat from the electrical connectors 102 or terminals 128 on the other side of the stack 108, for example by the fluid channel 117 being thermally coupled with those connectors 102 or terminals 128.

In the example shown, the flow path of the circuitous internal channel 117 is defined by internal ribs or projections 118 which extend partway into the internal chamber 119 from both lateral sides 111, 112 of the bladder 107. The internal ribs or projections 118 on the same lateral side 111, 112 are generally equidistant with respect to each other and the ribs or projections 118 on one lateral side 111, 112 are generally staggered or offset with respect to those on the other lateral side 111, 112. The ribs 118, which may be wall or a partition, thereby act as flow diverters as they cause the direction of the fluid in the internal fluid channel 117 to be changed or diverted such that it zig-zags or snakes across the width of the bladder 107 along its length.

The flow diverters 118 may be integrally formed within the bladder 107 and, as such, may be substantially planar internal walls within the bladder 107. Alternatively, they may be formed by adjoining the opposing top 109 and bottom 110 surfaces of the internal channel 117 together, for example by joining the top 109 and bottom 110 planar walls of the bladder 107 along a line so as to form a crease along which the top 109 and bottom 110 walls of the bladder 107 are joined. Any suitable means for adjoining the top 109 and bottom 110 walls of the bladder 107 together may be used, for example stitching, adhesives or heat sealing.

The bladder 107 is provided with a fluid inlet 122 on one of the shortest lateral sides 114 (the widthwise lateral side) and a fluid outlet 123 on the generally opposing, other shortest lateral side 113. The fluid inlet 122 and fluid outlets 123 are positioned substantially towards a corner of the bladder 107 and, as such, towards an end of the side faces 113, 114 on which they are provided. The fluid inlet 122 and fluid outlet 123 are fluidly coupled with the internal chamber 119 and, as such, with the internal fluid channel 117, so as to enable fluid to enter and exit the bladder 107 through the inlet 122 and outlet 123 respectively. Thus, in the example shown, fluid is shown as entering the bladder 107 from the left-hand side of FIG. 6 from an inlet fluid channel 120, through the inlet 122, flowing through the internal fluid channel 117 and then exiting the bladder 107 by flowing through the fluid outlet 123 on the right hand side of the figure, before then flowing through an outlet fluid channel 121.

In order to provide continuous flow through the bladder 107, the bladder 107 may be fluidly coupled or connected to a fluid circuit. A pumping means may be provided configured to pump fluid through the circuit and through the bladder 107.

The bladder 107 is substantially flexible and as such may be manufactured from a substantially or generally flexible material, such as nylon. Thus, the flexible bladder 107 provides that the underside surface 110 of the bladder 107 may ensure that the terminals 128 or connectors 102 maintain good thermal contact with the bladder 107 by accommodating for variations in the height of the electrical terminals 128 or connectors 102 due to, for example thermal expansion of the cells or due to manufacturing tolerances.

In some examples, the bladder 107 is configured such that it may expand or inflate. As the bladder 107 is generally or substantially flexible, internal pressurisation of the bladder 107, for example by applying pressure to the internal fluid channel 117, for example by pressurising fluid within the bladder 107, causes the bladder 107 to inflate or bulge. In the example shown, the bladder 107 is configured such that pressurisation of the internal fluid channel 117 causes the bladder 107 to expand or inflate, particularly in the vertical direction (i.e. in a direction generally perpendicular to the plane of the upper 109 or lower 110 surfaces of the bladder 107), such that it may provide a compressive force against the electrical terminals 128 or connectors 102 by pressing against them and thereby improve the thermal contact, and thereby the rate of heat transfer, between the terminals 128 or connectors 102 and the bladder 107.

The fluid channel 117 may be provided with electrically-inert fluid, for example electrical non-conductive fluid.

The heat exchanger 106, that is, in the example shown, the bladder 107, comprises a substantially electrically insulating and substantially thermally conductive material, such as a polymer, for example Nylon, which serves to, and is configured to, electrically insulate the electrical terminals 128 or electrical connectors 102 of each or different electrical cells thereby ensuring that the electrical terminals 128 are not electrically shorted. The bladder 107 comprises the substantially electrically insulating and substantially thermally conductive material at least on the areas of the external surface of the bladder 107, for example the underside surface 110, which directly contact the electrical terminals 128 or electrical connecting means 102. The bladder may also comprise boron, such as a boron filler or boron doped Nylon, for example the internal surface of the fluid channel 117 or chamber 119 may comprise boron.

Although the bladder 107 in the example shown, comprises substantially electrically insulating and substantially thermally conductive material at least on the areas of the external surface of the bladder 107 which are configured to directly contact the electrical connectors 102 or terminals 128 of the electrical cells 124, 125, 126, 127, the bladder 107 may also comprise such material elsewhere on its external surface and the material may completely cover the external surface of the bladder 107. In examples where the material is provided on the external surface of the bladder 107, spaced to correspond with the spacing of the electrical terminals 128 or interconnectors 102 so that, once assembled, the material directly contacts or overlies the terminals 128 or interconnectors 102, a length or stretch of this material may also extend, on the outer surface of the bladder 107, between these two patches to provide further electrical insulation between the terminals 128 or interconnectors 102 contacted by the material.

The substantially electrically insulating and substantially thermally conductive material may also extend at least in one area, or multiple areas, of the external surface 130 of the bladder 107, entirely through the external wall of the bladder 107 to the interior surface of the interior fluid channel 117 of the bladder 107. In the example shown, the bladder 107 is fabricated entirely from a single piece of substantially electrically insulating and substantially thermally conductive material such that the material forms both external and internal surfaces of the bladder 1007 and the thickness of the walls of the bladder 107 throughout its entire length.

In a preferred example, the bladder 107 is manufactured substantially entirely of the substantially electrically insulating and substantially thermally conductive material such that substantially the entirety of the external surface of the bladder 107 comprises such material and also such that the walls of the bladder 107 comprises such material throughout their thickness and further such that the surfaces of the internal chamber 119 or channel 117 comprises such material.

Although direct contact of the external surface of the bladder 107 is preferred, in other examples of the present invention, the bladder 107 may not directly contact the terminals 128 or interconnectors 102, there being one or more layers of additional material therebetween. Such material could, for example, be substantially electrically insulating. Other parts of the heat transfer means 101 other than the bladder 107 itself may also directly contact one or more of the electrical terminals 128 or interconnectors 102.

FIG. 7 shows a cross-sectional view of the heat transfer system 101 of FIG. 6. For clarity, the flow path is shown simplified in that the flow diverters 118 are not shown and the fluid flow is shown as only flowing into and out of the section of the fluid channel 117 illustrated, denoted by arrows A and B respectively.

Four pouch-type electrical cells 124, 125, 126, 127 are arranged back-to-back in a stack 108. All four electrical cells 124, 125, 126, 127 are electrically connected by U-shaped electrical brackets or interconnectors 102. Although in the example shown the interconnectors 102 are electrically and thermally coupled with the electrical terminals 128 (which may also be referred to as the electrical connectors) of the cell by physically connecting the brackets 102 to the terminals 128 by rivets 129, any other such suitable means of fastening may be used.

The configurations of the cells 124, 125, 126, 127, terminals 128 and interconnectors 102 are substantially the same as those of the first embodiment of the present invention and, as such, modifications suitable for the first embodiment, for example those discussed above in respect of the first embodiment, are generally equally suitable for the second embodiment shown in FIGS. 6 and 7. Similarly, apart from the bladder, the basic arrangement of the electrical system of the second embodiment is substantially the same as that of the first embodiment and, as such, any of the optional features of the first embodiment would be equally applicable to, and equally suitable for, the second embodiment.

The electrical terminals 128 of each cell are thermally and electrically connected to the internals of the pouch cells 124, 125, 126, 127, and therefore the terminals 128 provide a particularly efficient means of cooling the electrical cells 124, 125, 126 127, particularly where the electrical terminals 128 are constructed from highly thermally conductive material such as copper.

The first 124 and second 125 electrical cells are electrically coupled as two generally opposing terminals 128 of the first 124 and second 125 cells are electrically connected via the U-shaped interconnector 102 to which they are riveted. The other electrical terminal 128 of the second cell 125 is not shown because, due to the position of the line along which the section view is taken, it lies above the plane of the figure and so does not appear in FIG. 7. For the same reason, the first electrical terminal 128 of the third cell 126 is not shown. Although not shown, the second 125 and third 126 cells are electrically connected by a U-shaped bracket 102 in the same way as the first and second electrical cells 124, 125 are electrically connected.

The upper surface of the U-shaped interconnectors 102 directly contacts the underside surface 110 of the bladder 107, thereby enabling heat to be transferred from the electrical cells 124, 125, 126, 127, in particular their contents, to the underside surface 110 of the bladder 107. Heat may therefore pass through the wall of the bladder 107 to a surface 130 of the fluid channel 117 and then transferred to the fluid flowing with the fluid channel 117. Thus, heat from the cells 124, 125, 126, 127 may be continually removed from the cells 124, 125, 126, 127 and carried away by the fluid flow to be dissipated elsewhere.

In the example shown, the bladder 107 comprises substantially thermally conductive and substantially electrically insulating material such that the electrical cells 124, 125, 126, 127 remain electrically isolated, while ensuring that heat may be transferred through the walls of the bladder 107. In examples wherein the bladder 107 does not comprise a substantially electrically insulating material, an electrically insulating intermediate layer may be provided between the electrical interconnectors 102 or terminals 128 and the bladder 107 in order to prevent the electrical cells 124, 125, 126, 127 from shorting.

As the bladder 107 is generally flexible, its underside surface 130 is able to conform and adapt and thereby compensate for the increase or variation in the height of the interconnectors 102 or terminals 128 which may result for example due to thermal expansion or manufacturing tolerances, thereby ensuring good thermal contact between the electrical cells 124, 125, 126, 127 and the bladder 107. Furthermore, in examples wherein the bladder 107 is configured to inflate or expand, the bladder 107 may press against the electrical terminals 128 or connectors 102 and thereby improve the thermal contact and heat transfer between the cells 124, 125, 126, 127 and the bladder 107. When pressurised fluid is provided within the fluid channel 117 of the bladder 107, the bladder 107 may substantially expand such that it pushes against or is compressed against an upper plate, wall or ceiling 131 of the stack housing 101, which is arranged above the bladder 107, and the electrical connectors 102, thereby exerting an increased pressure on the terminals 102 as the inflatable bladder is sandwiched between the connectors 102 and the upper wall or plate 131 of the stack housing 101.

In addition to the vertical variability of the cells 124, 125, 126, 127, for example due to thermal expansion, thermal expansion may also cause the electrical cells 124, 125, 126, 127 to expand in the longitudinal direction of the stack 108 such that the position of the interconnectors 102 and terminals 128 may move relative to the housing 101 in use.

Examples wherein the bladder 107 comprises substantially thermally conductive and substantially electrically insulating material substantially on the entirety of the underside surface 110 of the bladder 107, the bladder 107 is able to accommodate such thermal expansion as the terminals 128 or interconnectors 102 remain in thermal contact with the bladder irrespective of their position relative to the underside 110 of the bladder 107.

In instances above in which Boron is mentioned, Boron Nitride may be used.

It is envisaged that the person skilled in the art may make various changes to the embodiments specifically described above without departing from the scope of the invention.

1-129. (canceled)

130. A heat transfer system for transferring heat from at least one electrical cell, the heat transfer system comprising:
an electrical system including at least one electrical cell and at least one electrical connector, each electrical connector configured to be in electrical and thermal communication with one of the at least one electrical cell; and
a heat transfer subsystem comprising a heat exchanger including an internal fluid channel or chamber, configured to be thermally coupled with at least one of the at least one electrical connectors such that heat may be transferred from the at least one electrical connector to the fluid channel, and configured to deform for substantial conformation with the at least one electrical connector.

131. The heat transfer system of claim 130, further comprising a substantially flexible bladder comprising an internal fluid channel or chamber configured to deform for substantial conformation with an electrical connector.

132. The heat transfer system of claim 131, wherein the bladder comprises a substantially thermally conductive and substantially electrically insulating material, configured such that heat may be transferred from the at least one electrical connector to fluid within the bladder through the substantially thermally conductive and substantially electrically insulating material.

133. The heat transfer system of claim 132, wherein the bladder is configured such that heat may be substantially transferred from at least two electrical connectors to the fluid within the bladder and wherein the substantially thermally conductive and substantially electrically insulating material extends continuously between at least two of the at least two electrical connectors.

134. The heat transfer system of claim 131, wherein the bladder is expandable and configured to substantially inflate or bulge upon internal pressurization of the bladder.

135. The heat transfer system of claim 130, wherein the internal fluid channel comprises flow diverters configured to alter the direction of a flow of fluid within the bladder, the flow diverters being arranged along substantially opposing sides of the bladder, along a same side of the bladder and spaced substantially equally apart from each other, or opposing sides of the bladder and staggered with respect to those on an opposing side.

136. The heat transfer system of claim 131, wherein the bladder comprises a fluid inlet and a fluid outlet, both configured to be in fluid communication with a plurality of internal fluid channels.

137. The heat transfer system of claim 131, wherein the bladder is fluidly connected to a fluid circuit comprising a fluid pump configured to pump fluid through the bladder.

138. The heat transfer system of claim 131, further comprising fluid within the bladder, wherein the fluid comprises a fire suppressant or retardant.

139. The heat transfer system of claim 130, comprising:
at least two electrical systems, configured to be in thermal and electrical communication with at least two electrical cells;
an electrical connecting subsystem configured to electrically connect at least two of the electrical connections; and
a heat transfer subsystem comprising a fluid conduit member comprising a fluid channel and a substantially thermally conductive and substantially electrically insulating material configured to contact at least two of the electrical connections, and configured such that heat may be substantially transferred from at least one of the at least two electrical connections, through the substantially thermally conductive and substantially electrically insulating material, to fluid within the fluid channel.

140. A heat transfer system for cooling a plurality of electrical cells comprising:
a plurality of electrical cells each having at least one electrical connection in electrical and thermal communication with a respective cell, and being electrically connected to one another through the at least one electrical connection, and
a heat transfer subsystem comprising a continuous and unbroken fluid conduit member comprising a fluid channel and a substantially thermally conductive and substantially electrically insulating material contacting the at least one electrical connection.

141. The heat transfer system of claim 140 comprising:
at least two electrical connections, each in electrical and thermal communication with any one of the plurality of electrical cells, wherein the substantially thermally conductive and substantially electrically insulating material passes, contacts, and extends continuously and unbrokenly between at least two of the at least two electrical connections.

142. The heat transfer system of claim 141, wherein the heat transfer subsystem is configured such that heat may be substantially transferred from at least two of the at least two electrical connections, through the substantially thermally conductive and substantially electrically insulating material, to fluid contained within the fluid conduit member.

143. The heat transfer system of claim 140, wherein the fluid channel is fluidly connected to a fluid circuit comprising a fluid pump configured to pump fluid through the fluid circuit.

144. The heat transfer system of claim 143, wherein the heat transfer subsystem comprises a plurality of the continuous and unbroken fluid conduit members, each comprising a fluid channel, wherein the fluid channels are fluidly connected in parallel with at least one fluid circuit, and the fluid pump is configured to pump fluid along the fluid channels.

145. The heat transfer system of claim 144, further comprising a heat exchanging subsystem configured to dissipate heat from a fluid within the fluid circuit.

146. A fire suppressant system for an electrical cell comprising:
a heat transfer subsystem comprising a plurality of fluid conduit members each comprising a fluid channel comprising a fluid containing a fire suppressant or retardant, wherein the heat transfer subsystem is configured to receive heat from at least one electrical cell and to release the fire suppressant or retardant substantially onto or around the at least one electrical cell when a predetermined temperature is reached.

147. The fire suppressant system of claim 146, wherein the fluid conduit member is configured to burst or mechanically fail and thereby release the fire suppressant fluid substantially onto or around the at least one electrical cell when the predetermined temperature is reached.

148. The fire suppressant system of claim 146, wherein at least one of the plurality of fluid conduit members is configured to release the fluid at a different predetermined temperature than the predetermined temperature at which another fluid conduit member is configured to release the fluid.

149. The fire suppressant system of claim 146, wherein at least one of the plurality of fluid conduit members is configured to release the fluid according to a temperature of a different component than the temperature of a component at which another fluid conduit member is configured to release the fluid, the components being selected from the group consisting of the electric cell, an electric connection of the at least one electrical cell, the heat transfer subsystem, the fluid conduit member, and the fluid.
